(19) United States
(12) Patent Application Publication
(10) Pub. No.: US 2003/0077221 A1
(43) Pub. Date: Apr. 24, 2003

(54) Aluminum oxide powders

(76) Inventors: Shivkumar Chiruvolu, Sunnyvale, CA (US); Yu K. Fortunak, Fremont, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/969,025

(22) Filed: Oct. 1, 2001

(51) Int. Cl. C01F 7/02

(52) U.S. Cl. 423/625; 423/628

(57) ABSTRACT

Collections of particles are described that include crystalline aluminum oxide selected from the group consisting of delta-Al₂O₃ and theta-Al₂O₃. The particles have an average diameter less than about 100 nm. The particles generally have correspondingly large BET surface areas. In certain embodiments, the particle collections are very uniform. In some embodiments, collections of particles include doped aluminum oxides particles with an average diameter less than about 500 nm. The collections of particles can be deposited as coatings. Methods are described for producing desired aluminum oxide particles.

### FIELD OF THE INVENTION

The invention relates to powders of aluminum oxide, especially powders formed from particles having a submicron average particle diameter. The invention further relates to submicron doped aluminum oxides.

### BACKGROUND OF THE INVENTION

Technological advances have increased the demand for improved material processing with strict tolerances on processing parameters. In particular, a variety of chemical powders can be used in many different processing contexts. For example, inorganic powders can be used as components in the production of electronic devices, such as flat panel displays, electronic circuits and optical and electro-optical materials.

With respect to specific materials of interest, aluminum oxides and doped aluminum oxides have desirable optical and luminescent properties for certain applications. Thus, aluminum oxides and doped aluminum oxides can be applied as glass coatings or powder coatings for optical transmission or display applications. Also, inorganic powders generally can be useful in chemical processing applications, in particular as catalysts. Aluminum oxide and doped aluminum oxide are useful as catalysts.

In addition, smooth planarized surfaces are required in a variety of applications in electronics, tool production and many other industries. The substrates requiring polishing can involve hard materials such as semiconductors, ceramics, glass and metal. As miniaturization continues even further, even more precise polishing will be required. Current submicron technology requires polishing accuracy on a nanometer scale. Precise polishing technology can employ mechanochemical polishing involving a polishing composition that acts by way of a chemical interaction of the substrate with the polishing agents as well as an abrasive effective for mechanical smoothing of the surface. Ultrafine powders of aluminum oxide with various crystal forms can be used as polishing agents.

### SUMMARY OF THE INVENTION

In a first aspect, the invention pertains to a collection of particles comprising crystalline aluminum oxide selected from the group consisting of delta-Al₂O₃ and theta-Al₂O₃. The particles have an average diameter less than about 100 nm.

In another aspect, the invention pertains to a collection of particles comprising doped aluminum oxides. The particles have an average diameter less than about 500 nm. In some embodiments, the invention pertains to a coating including the collection of doped aluminum oxide particles.

In a further aspect, the invention pertains to a method for the production of doped aluminum oxide particles. The method includes reacting a flowing reactant stream with an aluminum precursor, an oxygen source and a dopant precursor to form doped aluminum oxide particles in a flowing product stream.

In an additional aspect, the invention pertains to a method for producing product submicron crystalline-aluminum oxide particles. The method includes heating a collection of precursor submicron carbon-coated aluminum oxide particles in a reducing environment to convert the crystal structure of the aluminum oxide particles to produce product crystalline-aluminum oxide particles. The product crystalline aluminum oxide particles comprise particles with a different crystal structure than the precursor aluminum oxide particles.

### BRIEF DESCRIPTION OF THE DRAWINGS

FIG. 1 is a schematic, sectional view of an embodiment of a laser pyrolysis apparatus, where the cross section is taken through the middle of the radiation path. The upper insert is a bottom view of the collection nozzle, and the lower insert is a top view of the injection nozzle.

FIG. 2 is a schematic, side view of a reactant delivery apparatus for the delivery of vapor reactants to the laser pyrolysis apparatus of FIG. 1.

FIG. 3 is a schematic, sectional view of a reactant delivery apparatus for the delivery of an aerosol reactant to the laser pyrolysis apparatus of FIG. 1, the cross section being taken through the center of the apparatus.

FIG. 4 is a perspective view of an alternative embodiment of a laser pyrolysis apparatus.

FIG. 5 is a sectional view of the inlet nozzle of the alternative laser pyrolysis apparatus of FIG. 4, the cross section being taken along the length of the nozzle through its center.

FIG. 6 is a sectional view of the inlet nozzle of the alternative laser pyrolysis apparatus of FIG. 4, the cross section being taken along the width of the nozzle through its center.

FIG. 7 is a perspective view of an embodiment of an elongated reaction chamber for performing laser pyrolysis.

FIG. 8 is a schematic, sectional view of an apparatus for heat treating nanoparticles, in which the section is taken through the center of the apparatus.

FIG. 9 is a schematic, sectional view of an oven for heating nanoparticles, in which the section is taken through the center of a tube.

FIG. 10 is a schematic diagram of a light reactive deposition apparatus formed with a particle production apparatus connected to a separate coating chamber through a conduit.

FIG. 11 is a perspective view of a coating chamber where the walls of the chamber are transparent to permit viewing of the internal components.

FIG. 12 is perspective view of a particle nozzle directed at a substrate mounted on a rotating stage.

FIG. 13 is a schematic diagram of a light reactive deposition apparatus in which a particle coating is applied to a substrate within the particle production chamber.

FIG. 14 is a perspective view of a reactant nozzle delivering reactants to a reaction zone positioned near a substrate.

FIG. 15 is a sectional view of the apparatus of FIG. 14 taken along line 15-15.

FIG. 16 is a plot of five x-ray diffractograms for samples of aluminum oxide produced by laser pyrolysis produced with either vapor reactants or aerosol reactants. A line plot of the diffractogram peaks for delta-aluminum oxide is presented in the lower insert for comparison.

FIG. 17 is a transmission electron micrograph of a sample of aluminum oxide produced by laser pyrolysis with aerosol reactants.

FIG. 18 is a transmission electron micrograph of a sample of aluminum oxide particles produced by laser pyrolysis with vapor reactants.

FIG. 19 is a transmission electron micrograph of another sample of aluminum oxide particles produced by laser pyrolysis with vapor reactants.

FIG. 20 is a plot of an x-ray diffractogram for a sample of aluminum oxide particles following a heat treatment (upper curve) and a corresponding sample prior to heat treatment (lower plot) produced by laser pyrolysis with aerosol reactants. For comparison, a line plot of the diffractogram peaks for three phases of aluminum oxide are presented in the bottom of the figure.

FIG. 21 is a transmission electron micrograph of a sample of aluminum oxide particles following heat treatment in which the sample, prior to heat treatment, was produced by laser pyrolysis with aerosol reactants.

FIG. 22 is a plot of an x-ray diffractogram for three samples of aluminum oxide particles following a heat treatment (upper curves) and a representative sample prior to heat treatment (lower plot) produced by laser pyrolysis with vapor reactants. For comparison, a line plot of the diffractogram peaks for three phases of aluminum oxide are presented in the bottom of the figure.

FIG. 23 is a transmission electron micrograph of a sample of aluminum oxide particles following heat treatment in which the sample, prior to heat treatment, was produced by laser pyrolysis with vapor reactants.

FIG. 24 is a plot of x-ray diffractograms for a commercial sample of alpha-aluminum oxide (lower curve) and for a sample of alpha-aluminum oxide following the heat treatment of delta-aluminum oxide produced by laser pyrolysis with vapor reactants (upper curve). For comparison, a line plot of the diffractogram peaks for two phases of aluminum oxide are presented in the bottom of the figure.

### DETAILED DESCRIPTION OF THE INVENTION

Techniques have been developed for the production multiple crystalline phases of submicron and nanoscale aluminum oxide Al₂O₃, also referred to as alumina. The processes are based on the generation of aluminum oxide by laser pyrolysis, which uses a flowing reactant stream that intersects a strong light beam at a light reaction zone. In some of the embodiments, the reactant stream includes an aerosol with aluminum precursors, while in other embodiments the reactant stream includes exclusively vapor phase reactants. Doped aluminum oxide nanoparticles, crystalline or amorphous, can be produced using this approach by the introduction of suitable dopant precursors into the reactant stream as a vapor and/or an aerosol. Additional heat processing can be used to modify the properties of the material synthesized by laser pyrolysis. Crystalline or amorphous aluminum oxide materials can be deposited directly as a coating by light reactive deposition, which adapts the particle production features of laser pyrolysis for coating formation. Amorphous aluminum oxide materials can be combined with other glass formers, such as SiO₂ and/or P₂O₃.

To generate the desired nanoparticles, laser pyrolysis is used either alone or in combination with additional processing. Specifically, laser pyrolysis is an excellent process for efficiently producing suitable aluminum oxide particles with a narrow distribution of average particle diameters. In addition, nanoscale aluminum oxide particles produced by laser pyrolysis can be subjected to heating to alter and/or improve the properties of the particles. Specifically, the crystal structure of the aluminum oxide can be varied by heat processing.

A basic feature of successful application of laser pyrolysis for the production of aluminum oxide nanoparticles is the generation of a molecular stream containing an aluminum precursor compound, a radiation absorber and a reactant serving as an oxygen source. A dopant metal precursor can be introduced into the reactant stream in addition to the other reactants. Aerosol precursor delivery provides additional flexibility with respect to precursor selection. The composition of the reactant stream can be selected to yield the desired stoichiometry of the synthesized materials.

The molecular stream is pyrolyzed by an intense light beam, such as a laser beam. As the molecular stream leaves the laser beam, the particles are rapidly quenched to produce highly uniform particles. The oxygen, for incorporation into the oxide, can be initially bonded within the metal/metalloid precursors and/or can be supplied by a separate oxygen source, such as molecular oxygen. Similarly, unless the metal precursors and/or the oxygen source are an appropriate radiation absorber, an additional radiation absorber is added to the reactant stream.

Aluminum oxides are useful for a variety of applications. Potential applications of aluminum oxide submicron powders include, for example, chemical mechanical polishes, optical materials, luminescent materials and catalysts. The use of submicron gamma-aluminum oxide powders as polishing materials is described further in copending and commonly assigned U.S. patent application Ser. No. 09/433,202 to Reitz et al., entitled “Particle Dispersions,” incorporated herein by reference. The use of cobalt oxide doped aluminum oxide as a low bandgap thermophotovoltaic emitter is described in U.S. Pat. No. 5,865,906 to Ferguson et al., entitled “Energy-Band-Matched Infrared Emitter For Use With Low Bandgap Thermophotovoltaic Cells,” incorporated herein by reference. Zirconium-doped aluminum oxides are described for use as automobile exhaust catalysts in U.S. Pat. No. 5,089,247 to Liu et al., entitled “Process For Producing Zirconium-Doped Pseudoboehmite,” incorporated herein by reference. Aluminum oxides can have suitable optical properties for certain optical applications. In addition, some doped aluminum oxides have desirable optical properties. The use of dopes aluminum oxide glasses for optical applications is described, for example, in U.S. Pat. No. 4,225,330 to Kakuzen et al., entitled “Process For Producing Glass Member,” incorporated herein by reference.

For some applications, especially optical and luminescent applications, it may be desirable to deposit the powders directly as a coating. A process termed light reactive deposition has been developed that adapts the particle production capabilities of laser pyrolysis for direct coating production. In light reactive deposition, particle producing in a flowing stream at a light reaction zone are directed to a substrate surface in the reaction chamber or in a separate coating chamber. The high particle uniformity, small particle size and particle flux obtainable in light reactive deposition provides for the formation of very smooth uniform coatings.

### Particle Synthesis With A Reactant Flow

As noted above, laser pyrolysis is a valuable tool for the production of submicron and nanoscale aluminum oxide particles and doped aluminum oxide particles. Laser pyrolysis is a preferred approach for synthesizing the aluminum oxide particles because laser pyrolysis produces highly uniform and high purity product particles. Also, laser pyrolysis has the versatility to produce doped aluminum oxide particles with desired amounts and composition of dopants. The synthesis of gamma-aluminum oxide by laser pyrolysis using vapor phase reactant precursors is described in copending and commonly assigned U.S. patent application Ser. No. 09/136,483 to Kumar et al., entitled “Aluminum Oxide Particles,” incorporated herein by reference.

The reaction conditions determine the qualities of the particles produced by laser pyrolysis. The reaction conditions for laser pyrolysis can be controlled relatively precisely in order to produce particles with desired properties. The appropriate reaction conditions to produce a certain type of particles generally depend on the design of the particular apparatus. Specific conditions used to produce aluminum oxide particles in a particular apparatus are described below in the Examples. Furthermore, some general observations on the relationship between reaction conditions and the resulting particles can be made.

Increasing the light power results in increased reaction temperatures in the reaction region as well as a faster quenching rate. A rapid quenching rate tends to favor production of high-energy phases, which may not be obtained with processes near thermal equilibrium. Similarly, increasing the chamber pressure also tends to favor the production of higher energy structures. Also, increasing the concentration of the reactant serving as the oxygen source in the reactant stream favors the production of particles with increased amounts of oxygen.

Reactant flow rate and velocity of the reactant gas stream are inversely related to particle size so that increasing the reactant gas flow rate or velocity tends to result in smaller particle sizes. Light power also influences particle size with increased light power favoring larger particle formation for lower melting materials and smaller particle formation for higher melting materials. Also, the growth dynamics of the particles have a significant influence on the size of the resulting particles. In other words, different forms of a product compound have a tendency to form different size particles from other phases under relatively similar conditions. Similarly, in multiphase regions at which populations of particles with different compositions are formed, each population of particles generally has its own characteristic narrow distribution of particle sizes.

Laser pyrolysis has become the standard terminology for chemical reactions driven by an intense light radiation with rapid quenching of product after leaving a narrow reaction region defined by the light beam. The name, however, is a misnomer in the sense that a strong, incoherent, but focused light beam can replace the laser. Also, the reaction is not a pyrolysis in the sense of a thermal pyrolysis. The laser pyrolysis reaction is not thermally driven by the exothermic combustion of the reactants. In fact, some laser pyrolysis reactions can be conducted under conditions where no visible flame is observed from the reaction.

Oxides of particular interest include, for example, aluminum oxide Al₂O₃. Al₂O₃ has many potential crystal structures, as described further below. Doped aluminum oxides are also of interest. The desired amounts and composition of dopants generally depends on the particular application.

For example, suitable metal oxide dopants for aluminum oxide for optical glass formation include cesium oxide (Cs₂O), rubidium oxide (Rb₂O), thallium oxide (Tl₂O), lithium oxide (Li₂O), sodium oxide (Na₂O), potassium oxide (K₂O), beryllium oxide (BeO), magnesium oxide (MgO), calcium oxide (CaO), strontium oxide (SrO) and barium oxide (BaO). Glass dopants can affect, for example, the index-of-refraction, sintering temperature and/or the porosity of the glass. Suitable metal oxide dopants for infrared emitters include, for example, cobalt oxide (Co₃O₄). For automobile catalysts, a suitable dopant is zirconium oxide (ZrO₂). The reactant stream incorporates the appropriate blend of the dopant metal along with aluminum precursors and other reactants.

Laser pyrolysis can be performed with gas/vapor phase reactants. Many metal precursor compounds can be delivered into the reaction chamber as a gas/vapor. Appropriate metal/metalloid precursor compounds for gaseous delivery generally include metal/metalloid compounds with reasonable vapor pressures, i.e., vapor pressures sufficient to get desired amounts of precursor gas/vapor into the reactant stream.

The vessel holding liquid or solid precursor compounds can be heated to increase the vapor pressure of the metal/metalloid precursor, if desired. Solid precursors generally are heated to produce a sufficient vapor pressure. A carrier gas can be bubbled through a liquid precursor to facilitate delivery of a desired amount of precursor vapor. Similarly, a carrier gas can be passed over the solid precursor to facilitate delivery of the precursor vapor.

Suitable solid aluminum precursors for vapor delivery include, for example, aluminum chloride (AlCl₃), aluminum ethoxide (Al(OC₂H₅)₃), and aluminum isopropoxide (Al[OCH(CH₃)₂]₃). Suitable liquid, aluminum precursors for vapor delivery include, for example, aluminum s-butoxide (Al(OC4H₉)₃). Suitable liquid, cobalt precursors for vapor delivery include, for example, cobalt tricarbonyl nitrosyl (Co(CO)₃NO), and cobalt acetate (Co(OOCCH₃)₃). Suitable thallium precursors include, for example, thallium acetate (TlC₂H₃O₂). Additional dopant precursors can be selected by analogy with these representative precursors.

The use of exclusively gas phase reactants is somewhat limiting with respect to the types of precursor compounds that can be used conveniently. Thus, techniques have been developed to introduce aerosols containing metal/metalloid precursors into laser pyrolysis chambers. Suitable aerosol delivery apparatuses for reaction systems are described further in U.S. Pat. No. 6,193,936 to Gardner et al., entitled “Reactant Delivery Apparatuses,” incorporated herein by reference.

Using aerosol delivery apparatuses, solid precursor compounds can be delivered by dissolving the compounds in a solvent. Alternatively, powdered precursor compounds can be dispersed in a liquid/solvent for aerosol delivery. Liquid precursor compounds can be delivered as an aerosol from a neat liquid, a multiple liquid dispersion or a liquid solution. Aerosol reactants can be used to obtain a significant reactant throughput. A solvent/dispersant can be selected to achieve desired properties of the resulting solution/dispersion. Suitable solvents/dispersants include water, methanol, ethanol, isopropyl alcohol, other organic solvents and mixtures thereof. Some solvents, such as isopropyl alcohol, are significant absorbers of infrared light from a CO₂ laser such that no additional laser absorbing compound may be needed within the reactant stream if a CO₂ laser is used as a light source.

If aerosol precursors are formed with a solvent present, the solvent preferably is rapidly evaporated by the light beam in the reaction chamber such that a gas phase reaction can take place. Thus, the fundamental features of the laser pyrolysis reaction are unchanged by the presence of an aerosol. Nevertheless, the reaction conditions are affected by the presence of the aerosol. Below in the Examples, conditions are described for the production of nanoscale aluminum oxide particles using aerosol precursors in a particular laser pyrolysis reaction chamber. Thus, the parameters associated with aerosol reactant delivery can be explored further based on the description below.

A number of suitable solid, non-rare earth metal/metalloid precursor compounds can be delivered as an aerosol from solution. For example, aluminum nitrate (Al(NO₃)₃) is soluble in water. Cobaltous iodide (CoI₂), cobaltous bromide (CoBr₂), cobaltous chloride (CoCl₂), cobaltous acetate (Co(CH₃CO₂)₂) and cobaltous nitrate (Co(NO₃)₂) are soluble in water, alcohols and other organic solvents. Zirconium chloride (ZrCl4) is soluble in alcohol and ether, and zirconium nitrate (Zr(NO₃)₄) is soluble in water and alcohol. Thallium fluoride (TlF) and thallium nitrate (TlNO₃) are soluble in water. Rubidium chloride (RbCl) is soluble in water. Cesium chloride (CsI) and cesium nitrate (CsNO₃) are soluble in water. Other suitable dopant precursors can be similarly identified.

The precursor compounds for aerosol delivery can be dissolved in a solution preferably with a concentration greater than about 0.5 molar. Generally, if a greater concentration of precursor in the solution is used, a greater throughput of reactant through the reaction chamber is obtained. As the concentration increases, however, the solution can become more viscous such that the aerosol may have droplets with larger sizes than desired. Thus, selection of solution concentration can involve a balance of factors in the selection of a preferred solution concentration. In the formation of doped aluminum oxide particles, the relative amounts of the metal precursors, i.e., the dopant metals and aluminum, also influences the relative amount of the dopant metal(s) in the resulting aluminum oxide particles. Thus, the relative amounts of different metal precursors are selected to yield a desired product particle composition. For example, a solution for aerosol delivery can include a mixture of multiple metal oxide compositions, although the metal precursors can be delivered from different solutions and/or a combination of aerosol and vapor forms.

Preferred secondary reactants serving as an oxygen source include, for example, O₂, CO, H₂O, CO₂, O₃ and mixtures thereof, although the metal precursor can include oxygen such that no additional oxygen-containing reactant is needed. Molecular oxygen can be supplied as air. The secondary reactant compound should not react significantly with the metal/metalloid precursor(s) prior to entering the reaction zone since this generally would result in the formation of large particles. If the reactants are spontaneously reactive, the reactants can be delivered in separate nozzles into the reaction chamber such that they are combined just prior to reaching the light beam.

Laser pyrolysis can be performed with a variety of optical frequencies, using either a laser or other strong focused light source. Preferred light sources operate in the infrared portion of the electromagnetic spectrum. CO₂ lasers are particularly preferred sources of light. Infrared absorbers for inclusion in the reactant stream include, for example, C₂H₄, isopropyl alcohol, NH₃, SF₆, SiH₄ and O₃. O₃ can act as both an infrared absorber and as an oxygen source. The radiation absorber, such as the infrared absorber, absorbs energy from the radiation beam and distributes the energy to the other reactants to drive the pyrolysis.

When performing laser pyrolysis, the energy absorbed from the light beam preferably increases the temperature at a tremendous rate, many times the rate that heat generally would be produced by exothermic reactions under controlled condition. While the process generally involves nonequilibrium conditions, the temperature can be described approximately based on the energy in the absorbing region. The laser pyrolysis process is qualitatively different from the process in a combustion reactor where an energy source initiates a reaction, but the reaction is driven by energy given off by an exothermic reaction. Thus, while the light driven process is referred to as laser pyrolysis, it is generally not a purely thermal process even though traditional pyrolysis is a thermal process.

An inert shielding gas can be used to reduce the amount of reactant and product molecules contacting the reactant chamber components. Inert gases can also be introduced into the reactant stream as a carrier gas and/or as a reaction moderator. Appropriate inert gases include, for example, Ar, He and N₂.

An appropriate laser pyrolysis apparatus generally includes a reaction chamber isolated from the ambient environment. A reactant inlet connected to a reactant delivery apparatus produces a reactant stream with a gas flow through the reaction chamber. A light beam path intersects the reactant stream at a reaction zone. The reactant/product stream continues after the reaction zone to an outlet, where the reactant/product stream exits the reaction chamber and passes into a collection apparatus. Adaptation of laser pyrolysis for coating formation without separate particle collection is described further below in a process called light reactive deposition. Generally, the light source, such as a laser, is located external to the reaction chamber, and the light beam enters the reaction chamber through an appropriate window.

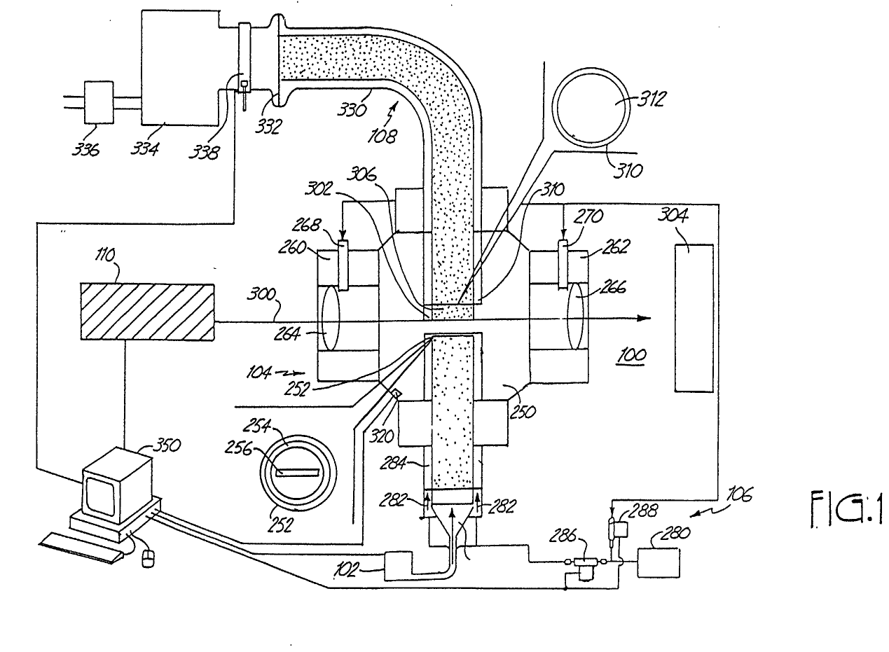

Referring to FIG. 1, a particular embodiment 100 of a laser pyrolysis system involves a reactant delivery apparatus 102, reaction chamber 104, shielding gas delivery apparatus 106, collection apparatus 108 and light source 110. A first reaction delivery apparatus described below can be used to deliver exclusively gaseous reactants. An alternative reactant delivery apparatus is described for delivery of one or more reactants as an aerosol.

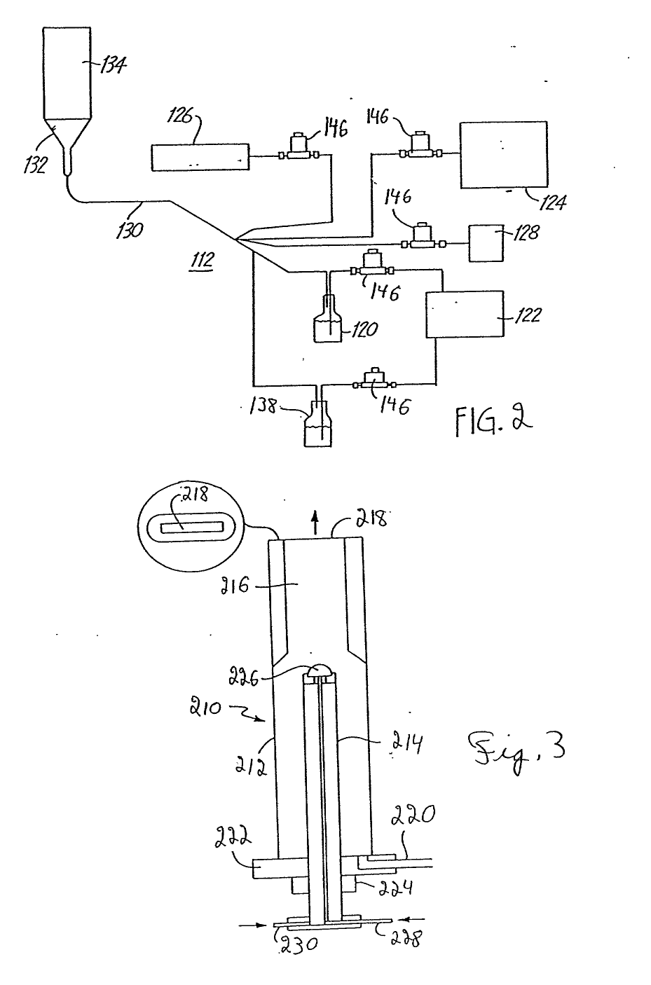

Referring to FIG. 2, a first embodiment 112 of reactant delivery apparatus 102 includes a source 120 of a precursor compound. For liquid or solid reactants, a carrier gas from one or more carrier gas sources 122 can be introduced into precursor source 120 to facilitate delivery of the reactant. Precursor source 120 can be a liquid holding container, a solid precursor delivery apparatus or other suitable container. The carrier gas from carrier gas source 122 preferably is either an infrared absorber and/or an inert gas.

The gases from precursor source 120 are mixed with gases from infrared absorber source 124, inert gas source 126 and/or secondary reactant/oxygen source 128 by combining the gases in a single portion of tubing 130. The gases are combined a sufficient distance from reaction chamber 104 such that the gases become well mixed prior to their entrance into reaction chamber 104. The combined gas in tube 130 passes through a duct 132 into channel 134, which is in fluid communication with reactant inlet 256 (FIG. 1).

A second reactant can be supplied from second metal precursor reactant source 138, which can be a liquid reactant delivery apparatus, a solid reactant delivery apparatus, a gas cylinder or other suitable container or containers. As shown in FIG. 2, second reactant source 138 delivers a second reactant to duct 132 by way of tube 130. Alternatively, mass flow controllers 146 can be used to regulate the flow of gases within the reactant delivery system of FIG. 2. In alternative embodiments, the second reactant can be delivered through a second duct for delivery into the reactant chamber through a second channel such that the reactants do not mix until they are in the reaction chamber. A laser pyrolysis apparatus with a plurality of reactant delivery nozzles is described further in copending and commonly assigned U.S. patent application Ser. No. 09/266,202 to Reitz et al., entitled “Zinc Oxide Particles,” incorporated herein by reference. Additional reactants can be similarly delivered.

As noted above, the reactant stream can include one or more aerosols. The aerosols can be formed within reaction chamber 104 or outside of reaction chamber 104 prior to injection into reaction chamber 104. If the aerosols are produced prior to injection into reaction chamber 104, the aerosols can be introduced through reactant inlets comparable to those used for gaseous reactants, such as reactant inlet 134 in FIG. 2.

Referring to FIG. 3, embodiment 210 of the reactant supply system 102 can be used to supply an aerosol to duct 132. Reactant supply system 210 includes an outer nozzle 212 and an inner nozzle 214. Outer nozzle 212 has an upper channel 216 that leads to a rectangular outlet 218 at the top of outer nozzle 212, as shown in the insert in FIG. 3. Rectangular outlet 218 has selected dimensions to produce a reactant stream of desired expanse within the reaction chamber. Outer nozzle 212 includes a drain tube 220 in base plate 222. Drain tube 220 is used to remove condensed aerosol from outer nozzle 212. Inner nozzle 214 is secured to outer nozzle 212 at fitting 224.

The top of inner nozzle 214 preferably is a twin orifice internal mix atomizer 226. Liquid is fed to the atomizer through tube 228, and gases for introduction into the reaction chamber are fed to the atomizer through tube 230. Interaction of the gas with the liquid assists with droplet formation. One or more metal precursors can be delivered by aerosol from a single solution by aerosol delivery. Similarly, one or more metal precursors can be also delivered as a vapor or a separate aerosol solution along with a first aerosol solution.

Referring to FIG. 1, the reaction chamber 104 includes a main chamber 250. Reactant supply system 102 connects to the main chamber 250 at injection nozzle 252. Reaction chamber 104 can be heated to a surface temperature above the dew point of the mixture of reactants and inert components at the pressure in the apparatus.

The end of injection nozzle 252 has an annular opening 254 for the passage of inert shielding gas, and a reactant inlet 256 (left lower insert) for the passage of reactants to form a reactant stream in the reaction chamber. Reactant inlet 256 preferably is a slit, as shown in the lower inserts of FIG. 1. Annular opening 254 has, for example, a diameter of about 1.5 inches and a width along the radial direction from about ⅛ in to about 1/16 in. The flow of shielding gas through annular opening 254 helps to prevent the spread of the reactant gases and product particles throughout reaction chamber 104.

Tubular sections 260, 262 are located on either side of injection nozzle 252. Tubular sections 260, 262 include, for example, ZnSe windows 264, 266, respectively. Windows 264, 266 are about 1 inch in diameter. Windows 264, 266 are preferably cylindrical lenses with a focal length equal to the distance between the center of the chamber to the surface of the lens to focus the light beam to a point just below the center of the nozzle opening. Windows 264, 266 preferably have an antireflective coating. Appropriate ZnSe lenses are available from Laser Power Optics, San Diego, Calif. Tubular sections 260, 262 provide for the displacement of windows 264, 266 away from main chamber 250 such that windows 264, 266 are less likely to be contaminated by reactants and/or products. Window 264, 266 are displaced, for example, about 3 cm from the edge of the main chamber 250.

Windows 264, 266 are sealed with a rubber o-ring to tubular sections 260, 262 to prevent the flow of ambient air into reaction chamber 104. Tubular inlets 268, 270 provide for the flow of shielding gas into tubular sections 260, 262 to reduce the contamination of windows 264, 266. Tubular inlets 268, 270 are connected to shielding gas delivery apparatus 106.

Referring to FIG. 1, shielding gas delivery system 106 includes inert gas source 280 connected to an inert gas duct 282. Inert gas duct 282 flows into annular channel 284 leading to annular opening 254. A mass flow controller 286 regulates the flow of inert gas into inert gas duct 282. If reactant delivery system 112 of FIG. 2 is used, inert gas source 126 can also function as the inert gas source for duct 282, if desired. Referring to FIG. 1, inert gas source 280 or a separate inert gas source can be used to supply inert gas to tubes 268, 270. Flow to tubes 268, 270 preferably is controlled by a mass flow controller 288.

Light source 110 is aligned to generate a light beam 300 that enters window 264 and exits window 266. Windows 264,266 define a light path through main chamber 250 intersecting the flow of reactants at reaction zone 302. After exiting window 266, light beam 300 strikes power meter 304, which also acts as a beam dump. An appropriate power meter is available from Coherent Inc., Santa Clara, Calif. Light source 110 can be a laser or an intense conventional light source such as an arc lamp. Preferably, light source 110 is an infrared laser, especially a CW CO₂ laser such as an 1800 watt maximum power output laser available from PRC Corp., Landing, N.J.

Reactants passing through reactant inlet 256 in injection nozzle 252 initiate a reactant stream. The reactant stream passes through reaction zone 302, where reaction involving the precursor compounds takes place. Heating of the gases in reaction zone 302 is extremely rapid, roughly on the order of 10⁵ degree C./sec depending on the specific conditions. The reaction is rapidly quenched upon leaving reaction zone 302, and particles 306 are formed in the reactant/product stream. The nonequilibrium nature of the process allows for the production of nanoparticles with a highly uniform size distribution and structural homogeneity.

The path of the reactant stream continues to collection nozzle 310. Collection nozzle 310 has a circular opening 312, as shown in the upper insert of FIG. 1. Circular opening 312 feeds into collection system 108.

The chamber pressure is monitored with a pressure gauge 320 attached to the main chamber. The preferred chamber pressure for the production of the desired oxides generally ranges from about 80 Torr to about 650 Torr.

Collection system 108 preferably includes a curved channel 330 leading from collection nozzle 310. Because of the small size of the particles, the product particles follow the flow of the gas around curves. Collection system 108 includes a filter 332 within the gas flow to collect the product particles. Due to curved section 330, the filter is not supported directly above the chamber. A variety of materials such as Teflon® (polytetrafluoroethylene), glass fibers and the like can be used for the filter as long as the material is inert and has a fine enough mesh to trap the particles. Preferred materials for the filter include, for example, a glass fiber filter from ACE Glass Inc., Vineland, N.J. and cylindrical Nomex® filters from AF Equipment Co., Sunnyvale, Calif.

Pump 334 is used to maintain collection system 108 at a selected pressure. It may be desirable to flow the exhaust of the pump through a scrubber 336 to remove any remaining reactive chemicals before venting into the atmosphere.

The pumping rate is controlled by either a manual needle valve or an automatic throttle valve 338 inserted between pump 334 and filter 332. As the chamber pressure increases due to the accumulation of particles on filter 332, the manual valve or the throttle valve can be adjusted to maintain the pumping rate and the corresponding chamber pressure.

The apparatus is controlled by a computer 350. Generally, the computer controls the light source and monitors the pressure in the reaction chamber. The computer can be used to control the flow of reactants and/or the shielding gas.

The reaction can be continued until sufficient particles are collected on filter 332 such that pump 334 can no longer maintain the desired pressure in the reaction chamber 104 against the resistance through filter 332. When the pressure in reaction chamber 104 can no longer be maintained at the desired value, the reaction is stopped, and filter 332 is removed. With this embodiment, about 1-300 grams of particles can be collected in a single run before the chamber pressure can no longer be maintained. A single run generally can last up to about 10 hours depending on the reactant delivery system, the type of particle being produced and the type of filter being used.

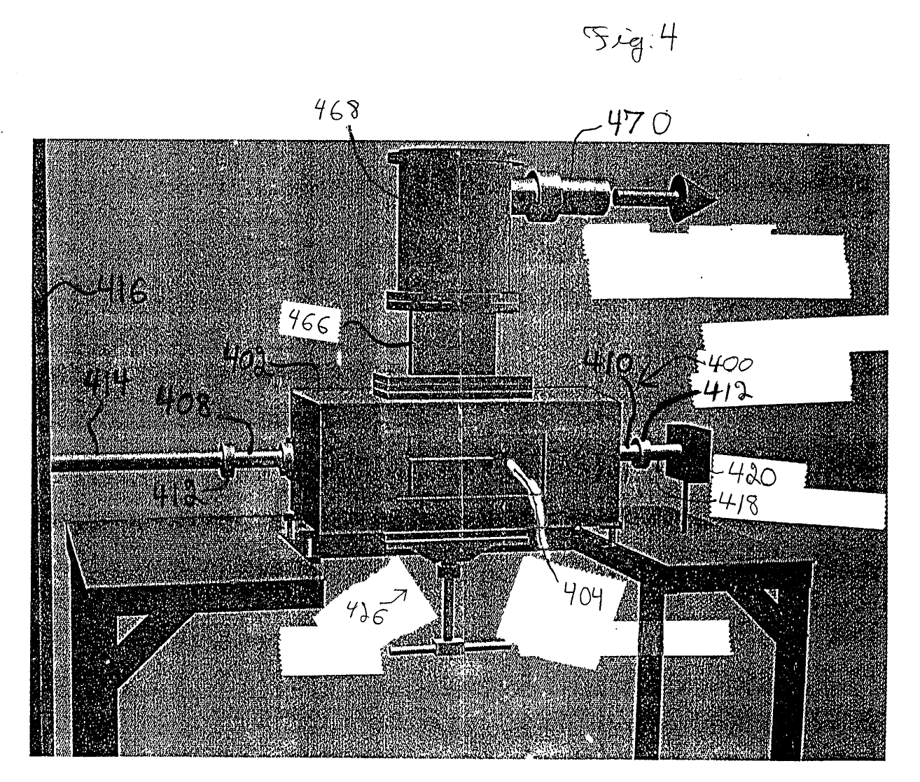

An alternative embodiment of a laser pyrolysis apparatus is shown in FIG. 4. Laser pyrolysis apparatus 400 includes a reaction chamber 402. The reaction chamber 402 has a shape of a rectangular parallelepiped. Reaction chamber 402 extends with its longest dimension along the laser beam. Reaction chamber 402 has a viewing window 404 at its side, such that the reaction zone can be observed during operation.

Reaction chamber 402 has tubular extensions 408, 410 that define an optical path through the reaction chamber. Tubular extension 408 is connected with a seal to a cylindrical lens 412. Tube 414 connects laser 416 or other optical source with lens 412. Similarly, tubular extension 410 is connected with a seal to tube 418, which further leads to beam dump/light meter 420. Thus, the entire light path from laser 416 to beam dump 420 is enclosed.

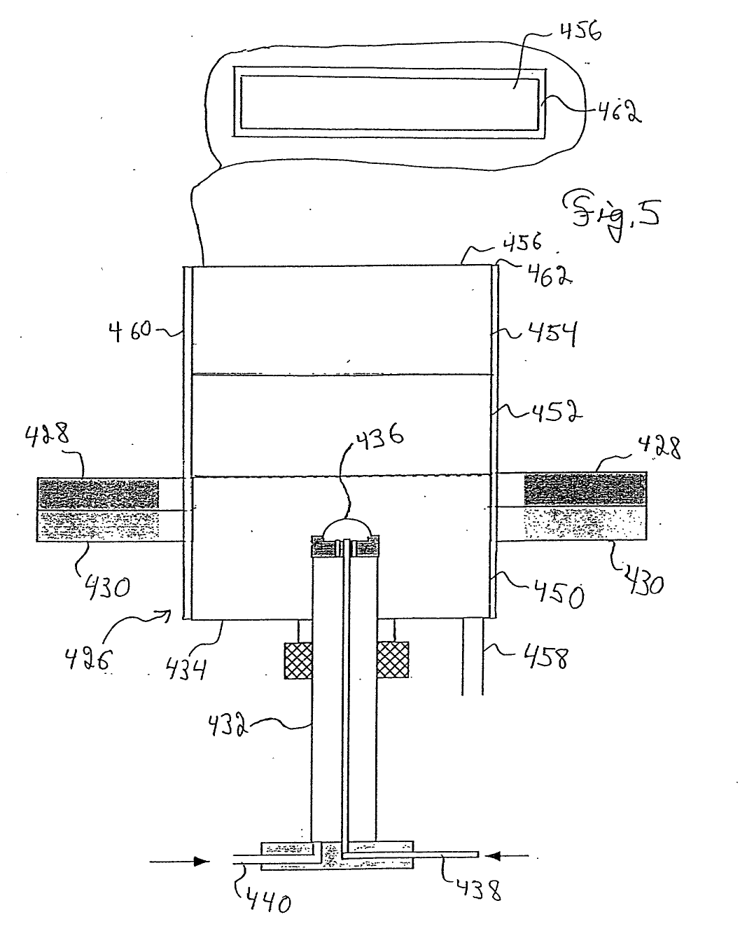

Inlet nozzle 426 connects with reaction chamber 402 at its lower surface 428. Inlet nozzle 426 includes a plate 430 that bolts into lower surface 428 to secure inlet nozzle 426. Referring to sectional views in FIGS. 5 and 6, inlet nozzle 426 includes an inner nozzle 432 and an outer nozzle 434. Inner nozzle 432 preferably has a twin orifice internal mix atomizer 436 at the top of the nozzle. Suitable gas atomizers are available from Spraying Systems, Wheaton, Ill. The twin orifice internal mix atomizer 436 has a fan shape to produce a thin sheet of aerosol and gaseous precursors. Liquid is fed to the atomizer through tube 438, and gases for introduction into the reaction chamber are fed to the atomizer through tube 440. Interaction of the gas with the liquid assists with droplet formation.

Outer nozzle 434 includes a chamber section 450, a funnel section 452 and a delivery section 454. Chamber section 450 holds the atomizer of inner nozzle 432. Funnel section 452 directs the aerosol and gaseous precursors into delivery section 454. Delivery section 450 leads to an about 3 inch by 0.5 inch rectangular outlet 456, shown in the insert of FIG. 5. Outer nozzle 434 includes a drain 458 to remove any liquid that collects in the outer nozzle. Outer nozzle 434 is covered by an outer wall 460 that forms a shielding gas opening 462 surrounding outlet 456. Inert gas is introduced through inlet 464.

Referring to FIG. 4, exit nozzle 466 connects to apparatus 400 at the top surface of reaction chamber 402. Exit nozzle 466 leads to filter chamber 468. Filter chamber 468 connects with pipe 470, which leads to a pump. A cylindrical filter is mounted at the opening to pipe 470. Suitable cylindrical filters are described above.

Another alternative design of a laser pyrolysis apparatus has been described in U.S. Pat. No. 5,958,348 to Bi et al., entitled “Efficient Production of Particles by Chemical Reaction,” incorporated herein by reference. This alternative design is intended to facilitate production of commercial quantities of particles by laser pyrolysis. Additional embodiments and other appropriate features for commercial capacity laser pyrolysis apparatuses are described in copending and commonly assigned U.S. patent application Ser. No. 09/362,631 to Mosso et al., entitled “Particle Production Apparatus,” incorporated herein by reference.

In one preferred embodiment of a commercial capacity laser pyrolysis apparatus, the reaction chamber and reactant inlet are elongated significantly along the light beam to provide for an increase in the throughput of reactants and products. The original design of the apparatus was based on the introduction of purely gaseous reactants. The embodiments described above for the delivery of aerosol reactants can be adapted for the elongated reaction chamber design. Additional embodiments for the introduction of an aerosol with one or more aerosol generators into an elongated reaction chamber are described in U.S. Pat. No. 6,193,936 to Gardner et al., entitled “Reactant Delivery Apparatuses,” incorporated herein by reference.

In general, the laser pyrolysis apparatus with the elongated reaction chamber and reactant inlet is designed to reduce contamination of the chamber walls, to increase the production capacity and to make efficient use of resources. To accomplish these objectives, the elongated reaction chamber provides for an increased throughput of reactants and products without a corresponding increase in the dead volume of the chamber. The dead volume of the chamber can become contaminated with unreacted compounds and/or reaction products. Furthermore, an appropriate flow of shielding gas confines the reactants and products within a flow stream through the reaction chamber. The high throughput of reactants makes efficient use of the laser energy.

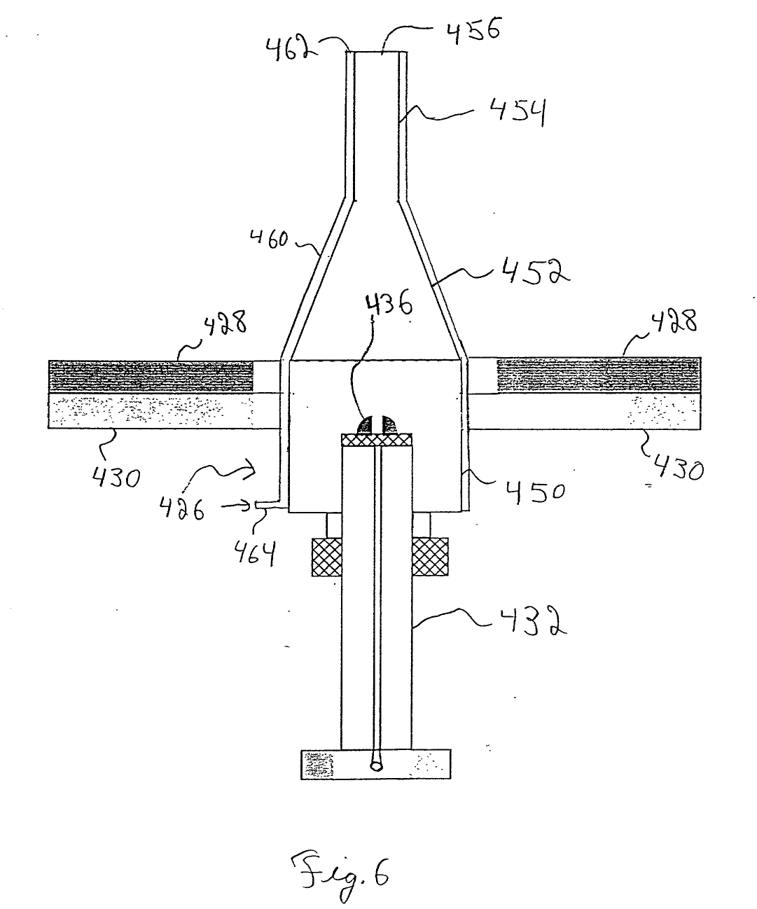

The design of the improved reaction chamber 472 is shown schematically in FIG. 7. A reactant inlet 474 leads to main chamber 476. Reactant inlet 474 conforms generally to the shape of main chamber 476. Main chamber 476 includes an outlet 478 along the reactant/product stream for removal of particulate products, any unreacted gases and inert gases. Shielding gas inlets 480 are located on both sides of reactant inlet 474. Shielding gas inlets are used to form a blanket of inert gases on the sides of the reactant stream to inhibit contact between the chamber walls and the reactants or products. The dimensions of elongated main chamber 476 and reactant inlet 474 preferably are designed for high efficiency particle production. Reasonable lengths for reactant inlet 474 for the production of ceramic nanoparticles, when used with a 1800 watt CO₂ laser, are from about 5 mm to about 1 meter.

Tubular sections 482, 484 extend from the main chamber 476. Tubular sections 482, 484 hold windows 486, 488 to define a light beam path 490 through the reaction chamber 472. Tubular sections 482, 484 can include inert gas inlets 492, 494 for the introduction of inert gas into tubular sections 482, 484.

The commercial scale reaction system includes a collection apparatus to remove the nanoparticles from the reactant stream. The collection system can be designed to collect particles in a batch mode with the collection of a large quantity of particles prior to terminating production. A filter or the like can be used to collect the particles in batch mode. Alternatively, the collection system can be designed to run in a continuous production mode by switching between different particle collectors within the collection apparatus or by providing for removal of particles without exposing the collection system to the ambient atmosphere. A preferred embodiment of a collection apparatus for continuous particle production is described in copending and commonly assigned U.S. patent application Ser. No. 09/107,729 to Gardner et al., entitled “Particle Collection Apparatus And Associated Methods,” incorporated herein by reference.

### Heat Processing

Significant properties of submicron and nanoscale particles can be modified by heat processing. Suitable starting submicron and nanoscale material for the heat treatment includes particles produced by laser pyrolysis. In addition, particles used as starting material for a heat treatment process can have been subjected to one or more prior heating steps under different conditions following synthesis of the particles. For the heat processing of particles formed by laser pyrolysis, the additional heat processing can improve/alter the crystallinity, remove contaminants, such as elemental carbon, and/or alter the stoichiometry, for example, by incorporation of additional oxygen or removal of oxygen or hydroxyl groups. In addition, heat processing can facilitate uniform incorporation of dopants.

Of particular interest, aluminum oxides and doped aluminum oxides formed by laser pyrolysis can be subjected to a heat processing step. The particles are heated in a box furnace or the like to provide generally uniform heating. This heat processing can convert these particles into desired high quality crystalline forms. The processing conditions generally are mild, such that undesirable amounts of particle sintering do not occur. Thus, the temperature of heating preferably is low relative to the melting point of the starting material and the product material. Specifically, the heat treatment can substantially maintain the submicron or nanoscale size and size uniformity of the particles from laser pyrolysis. In other words, particle size and surface area are not compromised significantly by thermal processing.

The atmosphere over the particles can be static, or gases can be flowed through the system. The atmosphere for the heating process can be an oxidizing atmosphere, a reducing atmosphere or an inert atmosphere. In particular, for conversion of amorphous particles to crystalline particles or from one crystalline structure to a different crystalline structure of essentially the same stoichiometry, the atmosphere generally can be inert.

Appropriate oxidizing gases include, for example, O₂, O₃, CO, CO₂, and combinations thereof. The O₂ can be supplied as air. Reducing gases include, for example, H₂ and NH₃. Oxidizing gases or reducing gases optionally can be mixed with inert gases such as Ar, He and N₂. When inert gas is mixed with the oxidizing/reducing gas, the gas mixture can include from about 1 percent oxidizing/reducing gas to about 99 percent oxidizing/reducing gas, and more preferably from about 5 percent oxidizing/reducing gas to about 99 percent oxidizing/reducing gas. Alternatively, either essentially pure oxidizing gas, pure reducing gas or pure inert gas can be used, as desired. Care must be taken with respect to the prevention of explosions when using highly concentrated reducing gases.

The precise conditions can be altered to vary the crystal structure of aluminum oxide particles that are produced. For example, the temperature, time of heating, heating and cooling rates, the surrounding gases and the exposure conditions with respect to the gases can all be selected to produce desired product particles. Generally, while heating under an oxidizing atmosphere, the longer the heating period the more oxygen that is incorporated into the material, prior to reaching equilibrium. Once equilibrium conditions are reached, the overall conditions determine the crystalline phase of the powders.

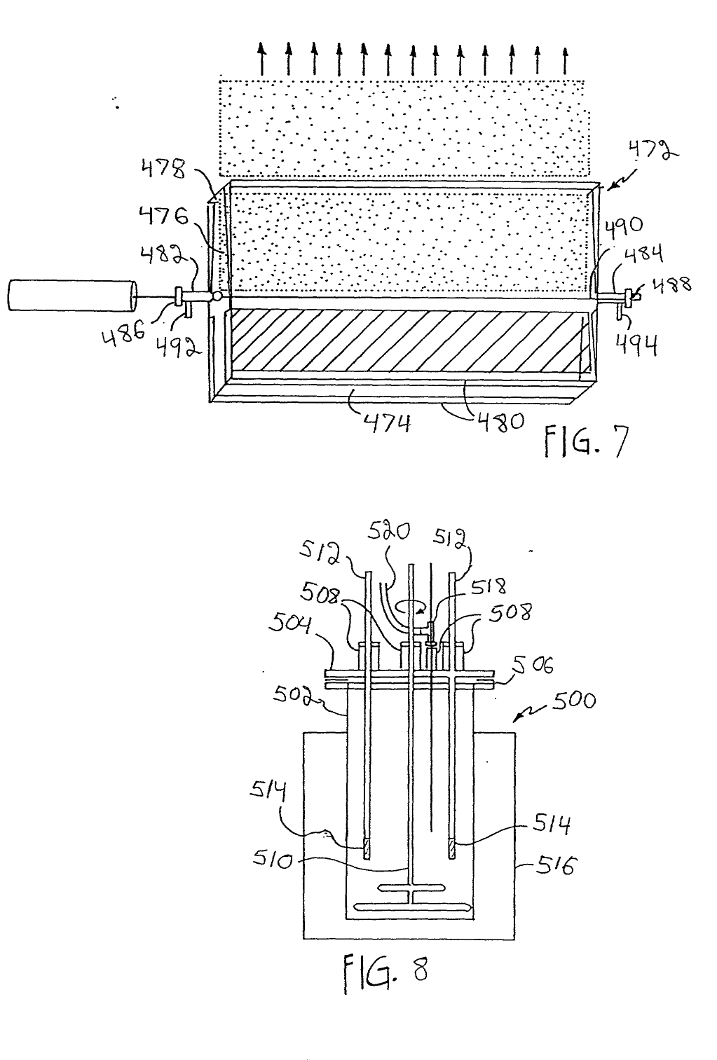

A variety of ovens or the like can be used to perform the heating. An example of an apparatus 500 to perform this processing is displayed in FIG. 8. Apparatus 500 includes a jar 502, which can be made from glass or other inert material, into which the particles are placed. Suitable glass reactor jars are available from Ace Glass (Vineland, N.J.). For higher temperatures, alloy jars can be used to replace the glass jars. The top of glass jar 502 is sealed to a glass cap 504, with a Teflon® gasket 506 between jar 502 and cap 504. Cap 504 can be held in place with one or more clamps. Cap 504 includes a plurality of ports 508, each with a Teflon® bushing. A multiblade stainless steel stirrer 510 preferably is inserted through a central port 508 in cap 504. Stirrer 510 is connected to a suitable motor.

One or more tubes 512 are inserted through ports 508 for the delivery of gases into jar 502. Tubes 512 can be made from stainless steel or other inert material. Diffusers 514 can be included at the tips of tubes 512 to disburse the gas within jar 502. A heater/furnace 516 generally is placed around jar 502. Suitable resistance heaters are available from Glas-col (Terre Haute, Ind.). One port preferably includes a T-connection 518. The temperature within jar 502 can be measured with a thermocouple 518 inserted through T-connection 518. T-connection 518 can be further connected to a vent 520. Vent 520 provides for the venting of gas circulated through jar 502. Preferably vent 520 is vented to a fume hood or alternative ventilation equipment.

Preferably, desired gases are flowed through jar 502. Tubes 512 generally are connected to one or more gas sources. Oxidizing gas, reducing gas, inert gas or a combination thereof to produce the desired atmosphere is placed within jar 502 from the appropriate gas source(s). Various flow rates can be used. The flow rate preferably is between about 1 standard cubic centimeter per minute (sccm) to about 1000 sccm and more preferably from about 10 sccm to about 500 sccm. The flow rate generally is constant through the processing step, although the flow rate and the composition of the gas can be varied systematically over time during processing, if desired. Alternatively, a static gas atmosphere can be used. A reducing gas source can replace oxidizing gas source 538.

An alternative apparatus 530 for the heat treatment of modest quantities of nanoparticles is shown in FIG. 9. The particles are placed within a boat 532 or the like within tube 534. Tube 534 can be produced from, for example, quartz, alumina or zirconia. Preferably, the desired gases are flowed through tube 534. Gases can be supplied for example from inert gas source 536 or oxidizing gas source 538.

Tube 534 is located within oven or furnace 540. Oven 540 can be adapted from a commercial furnace, such as Mini-Mite™ 1100° C. Tube Furnace from Lindberg/Blue M, Asheville, N.C. Oven 540 maintains the relevant portions of the tube at a relatively constant temperature, although the temperature can be varied systematically through the processing step, if desired. The temperature can be monitored with a thermocouple 542.

Preferred temperature ranges depend on the starting material and the target product aluminum oxide. For the processing of nanoscale aluminum oxide, the temperature preferably ranges from about 600° C. to about 1400° C. The particular temperatures will depend on the presence of a dopant and the desired crystal structure. The heating generally is continued for greater than about 5 minutes, and typically is continued for from about 10 minutes to about 120 hours, in most circumstances from about 10 minutes to about 5 hours. Preferred heating times also will depend on the presence or not of a dopant and the desired crystal structure. Some empirical adjustment may be helpful to produce the conditions appropriate for yielding a desired material. Typically, submicron and nanoscale powders can be processed at lower temperatures while still achieving the desired reaction. The use of mild conditions avoids significant inter-particle sintering resulting in larger particle sizes. To prevent particle growth, the particles preferably are heated for short periods of time at high temperatures or for longer periods of time at lower temperatures. Some controlled sintering of the particles can be performed at somewhat higher temperatures to produce slightly larger, average particle diameters.

As noted above, heat treatment can be used to perform a variety of desirable transformations for nanoparticles. The conditions to convert from delta, aluminum oxide to alpha-aluminum oxide are described in the examples below. In addition, the conditions to convert crystalline VO₂ to orthorhombic V₂O₅ and 2-D crystalline V₂O₅, and amorphous V₂O₅ to orthorhombic V₂O₅ and 2-D crystalline V₂O₅ are describe in U.S. Pat. No. 5,989,514, to Bi et al., entitled “Processing of Vanadium Oxide Particles With Heat,” incorporated herein by reference. Conditions for the removal of carbon coatings from metal oxide nanoparticles is described in copending and commonly assigned U.S. patent application Ser. No. 09/123,255, entitled “Metal (Silicon) Oxide/Carbon Composite Particles,” incorporated herein by reference. The incorporation of lithium from a lithium salt into metal oxide nanoparticles in a heat treatment process is described in copending and commonly assigned U.S. patent application Ser. No. 09/311,506 to Reitz et al., entitled “Metal Vanadium Oxide Particles,” and copending and commonly assigned U.S. patent application Ser. No. 09/334,203 to Kumar et al., entitled “Reaction Methods for Producing Ternary Particles,” both of which are incorporated herein by reference.

It has been discovered that high temperature phases of aluminum oxide can be generated with reduced or eliminated sintering by forming particles with carbon coatings by laser pyrolysis. The formation of carbon-coated metal oxide particles is described further in copending and commonly assigned U.S. patent application Ser. No. 09/123,255, entitled “Metal (Silicon) Oxide/Carbon Composite Particles,” incorporated herein by reference. The carbon coating results from the presence of a carbon source in the light reaction zone when conditions are appropriately adjusted. Specifically, high chamber pressures and high laser powers are conducive to carbon coating formation.

When the carbon-coated particles are heat treated, the carbon coating isolates the particles from adjacent particles such that the particles do not significantly sinter and combine or fuse. The heat treatment should be performed in a non-oxidizing atmosphere such that the carbon coating is not burned off. In this way, very fine alpha-aluminum oxide can be formed without significantly sintering the particles. For the formation of alpha-aluminum oxide, the particles are preferably heated to a temperature from about 1000° C. to about 1400° C. and more preferably from about 1100° C. to about 1350° C. Following formation of the desired crystalline form of aluminum oxide, the carbon-coated particles can be heated under oxidizing conditions at mild temperatures, approximately 500° C., to remove the carbon.

### Particle Properties

A collection of particles of interest generally has an average diameter for the primary particles of less than about 1000 nm, in most embodiments less than about 500 nm, in other embodiments from about 2 nm to about 100 nm, in further embodiments from about 3 nm to about 75 nm, additional embodiments from about 5 nm to about 50 nm and in still other embodiments from about 5 nm to about 25 nm. A person of ordinary skill in the art will recognize that average diameter ranges within these specific ranges are also contemplated and are within the present disclosure. Particle diameters generally are evaluated by transmission electron microscopy. Diameter measurements on particles with asymmetries are based on an average of length measurements along the principle axes of the particle.

The primary particles usually have a roughly spherical gross appearance. While the particles may appear roughly spherical, upon closer examination crystalline particles generally have facets corresponding to the underlying crystal lattice. Nevertheless, crystalline primary particles tend to exhibit growth in laser pyrolysis that is roughly equal in the three physical dimensions to give a gross spherical appearance. Amorphous particles generally have an even more spherical aspect. In some embodiments, 95 percent of the primary particles, and preferably 99 percent, have ratios of the dimension along the major axis to the dimension along the minor axis less than about 2. In some embodiments, the crystal lattice may tend to result in non-spherical particles. The non-spherical aspect may be particularly pronounced following a heat treatment.

Because of their small size, the primary particles tend to form loose agglomerates due to van der Waals and other electromagnetic forces between nearby particles. These agglomerates can be dispersed to a significant degree, if desired. Even though the particles form loose agglomerates, the nanometer scale of the primary particles is clearly observable in transmission electron micrographs of the particles. The particles generally have a surface area corresponding to particles on a nanometer scale as observed in the micrographs. Furthermore, the particles can manifest unique properties due to their small size and large surface area per weight of material. For example, vanadium oxide nanoparticles can exhibit surprisingly high energy densities in lithium batteries, as described in U.S. Pat. No. 5,952,125 to Bi et al., entitled “Batteries With Electroactive Nanoparticles,” incorporated herein by reference.

The primary particles preferably have a high degree of uniformity in size. Laser pyrolysis, as described above, generally results in particles having a very narrow range of particle diameters. Size uniformity, however, may be sensitive to processing conditions in the laser pyrolysis apparatus. Furthermore, heat processing under suitably mild conditions does not alter the very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the primary particles generally have a distribution in sizes such that at least about 95 percent, and preferably 99 percent, of the primary particles have a diameter greater than about 40 percent of the average diameter and less than about 225 percent of the average diameter. Preferably, the primary particles have a distribution of diameters such that at least about 95 percent, and preferably 99 percent, of the primary particles have a diameter greater than about 45 percent of the average diameter and less than about 200 percent of the average diameter.

Furthermore, in preferred embodiments no primary particles have an average diameter greater than about 5 times the average diameter and preferably 4 times the average diameter, and more preferably 3 times the average diameter. In other words, the particle size distribution effectively does not have a tail indicative of a small number of particles with significantly larger sizes. This is a result of the small reaction region and corresponding rapid quench of the particles. An effective cut off in the tail of the size distribution indicates that there are less than about 1 particle in 10⁶ have a diameter greater than a specified cut off value above the average diameter. Narrow size distributions, lack of a tail in the distributions and the roughly spherical morphology can be exploited in a variety of applications.

A property related to particle size is the particle surface area. The BET surface area is established in the field as an approach to particle surface area measurement. The BET surface area is measured by adsorbing gas onto the surface of the particles. The quantity of gas adsorbed onto the particle is correlated with a surface area measurement. An inert gas is used as the adsorbent gas. Suitable inert gases include, for example, Ar and N₂. Surface area measurements are also sensitive to porosity of the particles with porous particles having a higher surface area. Preferred collections of particles have a BET surface area of at least about 10 m²/g, in some embodiments at least about 30 m²/g, and in other embodiments from about 100 m²/g to about 200 m²/g.

In addition, the nanoparticles generally have a very high purity level. The nanoparticles produced by the above described methods are expected to have a purity greater than the reactants because the laser pyrolysis reaction and, when applicable, the crystal formation process tends to exclude contaminants from the particle. Furthermore, crystalline nanoparticles produced by laser pyrolysis have a high degree of crystallinity. Similarly, the crystalline nanoparticles produced by heat processing have a high degree of crystallinity. Certain impurities if present on the surface of the particles may be removed by heating the particles to achieve not only high crystalline purity but high purity overall.

Aluminum oxide is known to exist in several crystalline phases including α-Al₂O₃, δ-Al₂O₃, γ-Al₂O₃, ε-Al₂O₃, θ-Al₂O₃, and η-Al₂O₃. For example, the delta (δ) phase has a tetragonal crystal structure, and the gamma (γ) phase has a cubic crystal structure. Heat treatment of gamma(γ) -aluminum oxide yields, with successively increasing equilibrium temperatures, delta(δ) -aluminum oxide, theta(θ)-aluminum oxide and alpha(α)-aluminum oxide. Thus, heat treatment of delta(δ)-aluminum oxide can result in theta(θ)-aluminum oxide and alpha(α)-aluminum oxide, and heat treatment of theta(θ)-aluminum oxide can result in alpha(α)-aluminum oxide. Heat treatment for shorter periods of time may result in intermediate crystal structures with lower equilibrium temperatures. Transformation by heat treatment of gamma-aluminum oxide to delta- or theta-aluminum oxide can occur without destruction of the original crystal morphology. The conversion of delta- or theta-aluminum oxide to alpha-aluminum oxide is reconstructive and can occur by nucleation and growth processes.

Although under certain conditions mixed phase materials are formed, laser pyrolysis generally can be used effectively to produce single phase crystalline particles. The conditions of the laser pyrolysis can be varied to favor the formation of a single, selected phase of crystalline Al₂O₃. Amorphous aluminum oxide can also be formed. Conditions favoring the formation of amorphous particles include, for example, high pressures, high flow rates, high laser power and combinations thereof.

Metal oxide dopants involve the incorporation of other metal oxides within the aluminum oxide crystal. While the dopant may distort the aluminum oxide crystal lattice, the fundamental features of the aluminum oxide crystal lattice are identifiable with the dopant present. Desirable dopants are selected based on the intended use of the materials. Some dopants for particular applications are described above. In general, the doped aluminum oxide includes no more than about 10 mole percent of dopant oxides. In many embodiments, the doped aluminum oxide includes form about 0.01 mole percent to about 5 mole percent and in other embodiments from about 0.05 mole percent to about 1 mole percent. A person of skill in the art will recognize that the invention covers mole percent ranges intermediate between these explicit ranges. Dopants may coat the surface, although they are generally incorporated into the lattice of the host material.

### Coating Deposition

Light reactive deposition is a coating approach that uses an intense light source to drive synthesis of desired composition from a reactant stream. It has similarities with laser pyrolysis in that an intense light source drives the reaction. However, in light reactive deposition, the resulting compositions are directed to a substrate surface where a coating is formed. The characteristics of laser pyrolysis that lead to the production of highly uniform particles result in the production of coatings with high uniformity. Also, light reactive deposition maintains the versatility of laser pyrolysis with respect to the ability to form materials with a wide range of composition.

In light reactive deposition, the coating of the substrate can be performed in a coating chamber separate from the reaction chamber or the coating can be performed within the reaction chamber. In either of these configurations, the reactant delivery system can be configured similar to a reactant delivery system for a laser pyrolysis apparatus for the production of aluminum oxides or doped aluminum oxides. Thus, the description of the production of aluminum oxide particles by laser pyrolysis described above and in the examples below can be adapted for coating production using the approaches described in this section.

If the coating is performed in a coating chamber separate from the reaction chamber, the reaction chamber is essentially the same as the reaction chamber for performing laser pyrolysis, although the throughput and the reactant stream size may be designed to be appropriate for the coating process. For these embodiments, the coating chamber and a conduit connecting the coating chamber with the reaction chamber replace the collection system of the laser pyrolysis system.

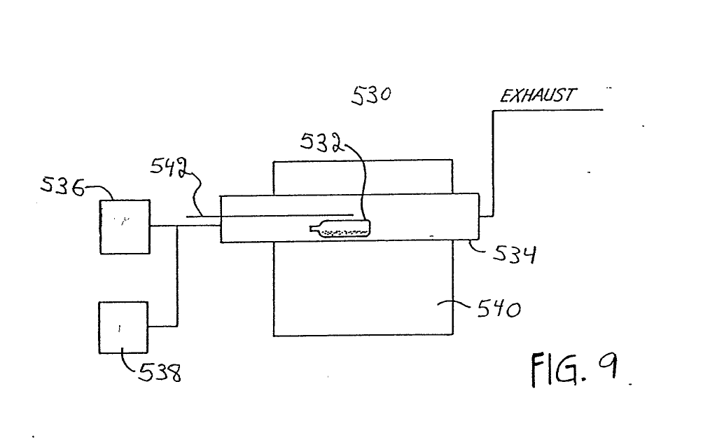

A coating apparatus with a separate reaction chamber and a coating chamber is shown schematically in FIG. 10. Referring to FIG. 10, the coating apparatus 556 comprises a reaction chamber 558, a coating chamber 560, a conduit 562 connecting the reaction apparatus with coating chamber 560, an exhaust conduit 564 leading from coating chamber 560 and a pump 566 connected to exhaust conduit 564. A valve 568 can be used to control the flow to pump 566. Valve 568 can be, for example, a manual needle valve or an automatic throttle valve. Valve 568 can be used to control the pumping rate and the corresponding chamber pressures.

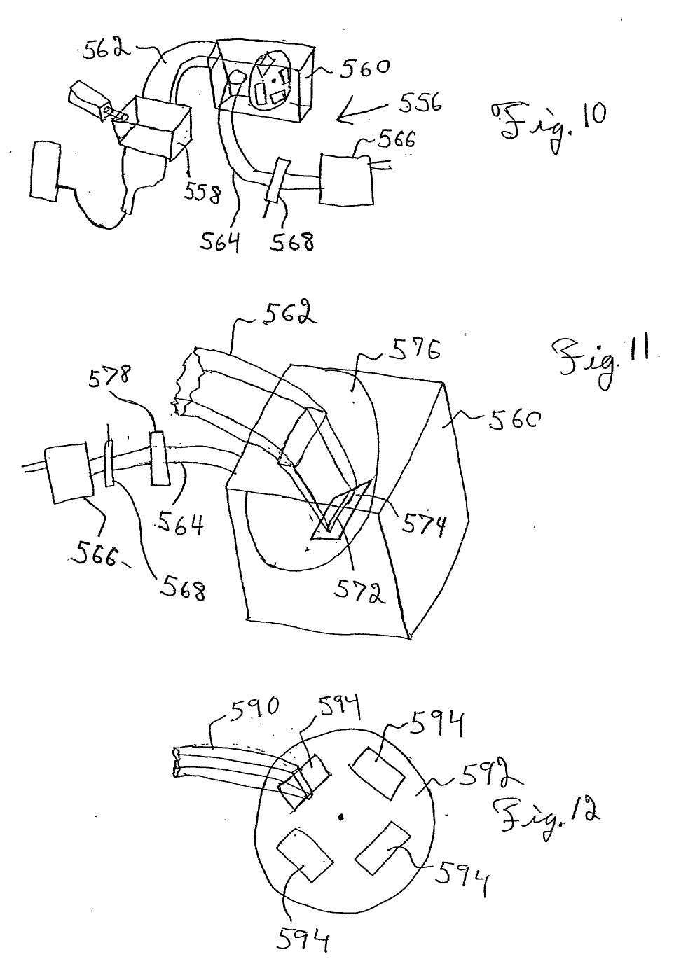

Referring to FIG. 11, conduit 562 from the particle production apparatus 558 leads to coating chamber 560. Conduit 562 terminates at opening 572 within chamber 560. In some preferred embodiments, opening 572 is located near the surface of substrate 574 such that the momentum of the particle stream directs the particles directly onto the surface of substrate 574. Substrate 574 can be mounted on a stage or other platform 576 to position substrate 574 relative to opening 572. A collection system, filter, scrubber or the like 578 can be placed between the coating chamber 560 and pump 566 to remove particles that did not get coated onto the substrate surface.

An embodiment of a stage to position a substrate relative to the conduit from the particle production apparatus is shown in FIG. 12. A particle nozzle 590 directs particles toward a rotating stage 592. As shown in FIG. 12, four substrates 594 are mounted on stage 592. More or fewer substrates can be mounted on a moveable stage with corresponding modifications to the stage and size of the chamber. Movement of stage 592 sweeps the particle stream across a substrate surface and positions particular substrate 594 within the path of nozzle 590. As shown in FIG. 12, a motor is used to rotate stage 592. Stage 592 preferably includes thermal control features that provide for the control of the temperature of the substrates on stage 592. Alternative designs involve the linear movement of a stage or other motions. In other embodiments, the particle stream is unfocused such that an entire substrate or the desired portions thereof is simultaneously coated without moving the substrate relative to the product flow.

If the coating is performed within the reaction chamber, the substrate is mounted to receive product compositions flowing from the reaction zone. The compositions may not be fully solidified into solid particles, although quenching may be fast enough to form solid particles. Whether or not the compositions are solidified into solid particles, the particles are preferably highly uniform. In some embodiments, the substrate is mounted near the reaction zone.

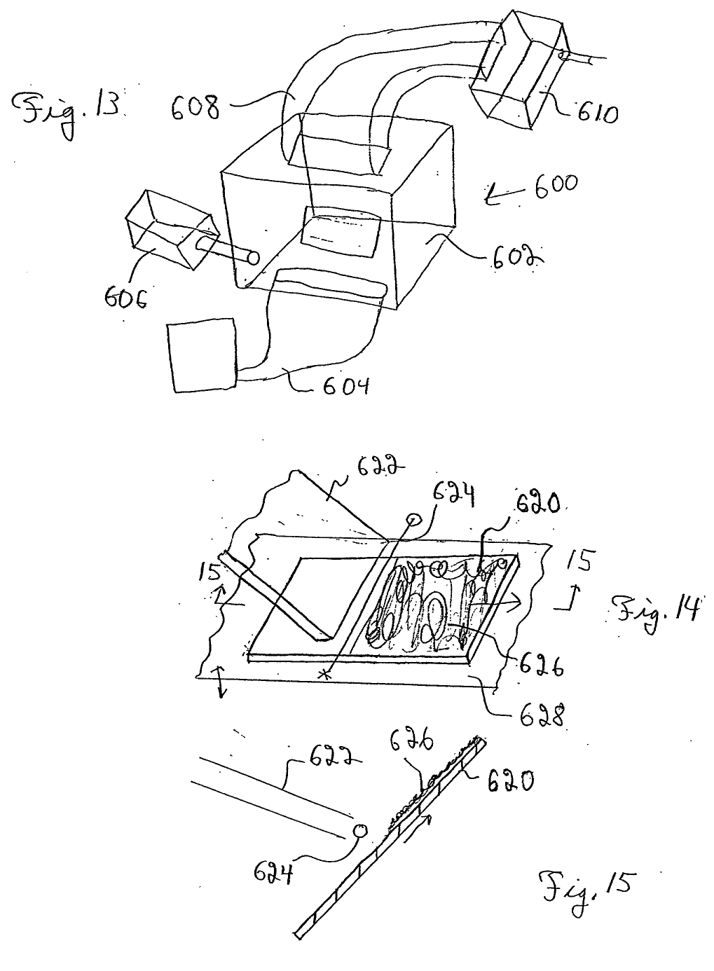

An apparatus 600 to perform substrate coating within the reaction chamber is shown schematically in FIG. 13. The reaction/coating chamber 602 is connected to a reactant supply system 604, a radiation source 606 and an exhaust 608. Exhaust 608 can be connected to a pump 610, although the pressure from the reactants themselves can maintain flow through the system.

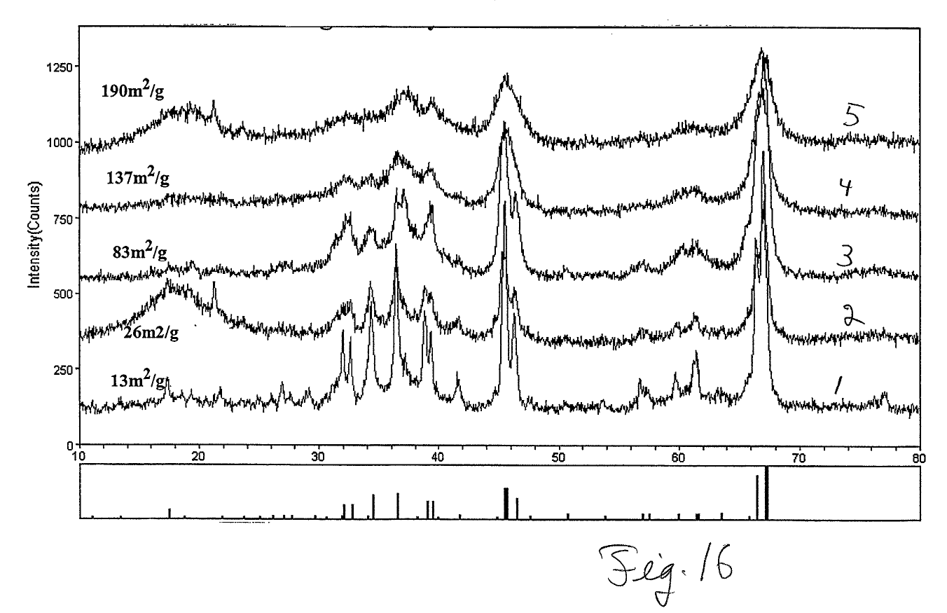

Various configurations can be used to sweep the coating across the substrate surface as the product leaves the reaction zone. One embodiment is shown in FIGS. 14 and 15. A substrate 620 moves relative to a reactant nozzle 622, as indicated by the right directed arrow. Reactant nozzle 622 is located just above substrate 620. An optical path 624 is defined by suitable optical elements that direct a light beam along path 624. Optical path 624 is located between nozzle 622 and substrate 620 to define a reaction zone just above the surface of substrate 620. The hot particles tend to stick to the cooler substrate surface. A sectional view is shown in FIG. 15. A particle coating 626 is formed as the substrate is scanned past the reaction zone.

In general, substrate 620 can be carried on a conveyor 628. In some embodiments, the position of conveyor 628 can be adjusted to alter the distance from substrate 626 to the reaction zone. Changes in the distance from substrate to the reaction zone correspondingly change the temperature of the particles striking the substrate. The temperature of the particles striking the substrate may alter the properties of the resulting coating and the requirements for subsequent processing, such as heat processing for consolidation of the coating. The distance between the substrate and the reaction zone can be adjusted empirically to produce desired coating properties. In addition, the stage/conveyor supporting the substrate can include thermal control features such that the temperature of the substrate can be adjusted to higher or lower temperatures, as desired.

For the production of discrete devices or structures on a substrate surface formed by the coating formed by the coating process, the deposition process can be designed to only coat a portion of the substrate. Alternatively, various patterning approaches can be used. For example, conventional approaches from integrated circuit manufacturing, such as photolithography and dry etching, can be used to pattern the coating following deposition.

Before or after patterning, the coating can be heat processed to transform the coating from a layer of discrete particles into a continuous layer. In some preferred embodiments, particles in the coating are heated to consolidate the particles into a glass or a uniform crystalline layer. The materials can be heated just above the melting point of the material to consolidate the coating into a smooth uniform material. If the temperature is not raised too high, the material does not flow significantly although the powders do convert to a homogenous material. The heating and quenching times can be adjusted to change the properties of the consolidated coatings.

Based on this description, the formation of coatings with phosphate glasses and crystalline material can be formed on substrates. The coatings can be used as protective coatings or for other functions.

The formation of coatings by light reactive deposition, silicon glass deposition and optical devices are described further in copending and commonly assigned U.S. patent application Ser. No. 09/715,935 to Bi et al., entitled “COATING FORMATION BY REACTIVE DEPOSITION,” incorporated herein by reference.

### Processing to Form Desired Oxides

A variety of aluminum oxide materials can be produced based on the description herein. Specifically, the processes are directed to powder production, but the powders can be applied as coatings that can be processed into uniform layers. The powders and uniform layers can be amorphous glasses or crystalline. The crystal forms can take one of several different forms. Any of these material forms can be Al₂O₃ or doped Al₂O₃.

Aluminum oxide powders are particularly suitable for incorporation into polishing compositions and for catalyst applications. Powders are produced by laser pyrolysis and collected. Optical materials preferably are formed as coatings using light reactive deposition, although powders can be processed into optical devices in alternative approaches based on the application of collected powders. In applications based on the luminescent properties of doped aluminum oxide, the materials can be processed as powders or as coatings to form a variety of devices such as optical displays.

Powders and coatings are generally processed further with a heat treatment. The conditions for the heat treatment generally depend on the desired product form. Amorphous particles generally are used for the formation of a glass product. To maintain the amorphous nature to obtain a glass, the heat treatment generally should be relatively short with a reasonably rapid quench. To form a uniform glass, the particles are heated above their flow temperature. The temperature is maintained long enough for the particles to compact and to flow into the desires uniform material. Even if amorphous particles are desired as the final product, it may be desirable to heat treat the particles to remove contaminants, to improve the uniformity of the materials and, if dopants are present, to improve the incorporation of the dopants into the aluminum oxide materials. The heat treatment should be performed under carefully controlled mild conditions to maintain the amorphous character of the particles.

To form a crystalline material, the powders preferably are formed under conditions that result in crystalline particles in their initial formation process. Further processing generally results in crystalline product. In these embodiments, the heat treatment can be performed to produce the equilibrium product. However, stopping at earlier times can result in the production of different crystalline forms. Laser pyrolysis can result in the formation of gamma-Al₂O₃, which has a boehmite crystal structure. The synthesis of gamma-aluminum oxide by laser pyrolysis using vapor phase reactant precursors is described in copending and commonly assigned U.S. patent application Ser. No. 09/136,483 to Kumar et al., entitled “Aluminum Oxide Particles,” incorporated herein by reference. In the example below, the formation of delta-aluminum oxide using aerosol precursors and vapor precursors is described. Heating of gamma-aluminum oxide results in the formation sequentially of delta-Al₂O₃, theta-Al₂O₃ and alpha-A₂O₃. Alpha-aluminum oxide is the thermodynamically stable form of aluminum oxide upon heating to temperature above about 1000° C. The formation of delta-Al₂O₃, theta-Al₂O₃ and alpha-Al₂O₃, starting from gamma-Al₂O₃ is described in the examples below.

Dopants can be introduced into any of the crystal forms of Al₂O₃. Dopant ingredients are preferably introduced into precursor stream for the laser pyrolysis synthesis. The processing steps should be relatively comparable with the presence of the dopants, although some dopants will have significant effects on the processing temperatures. In particular, some dopants are effective at lowering melting temperatures and glass transition temperatures. Alteration of processing conditions based on dopants can be performed empirically. Evaluation of the crystal structure can be performed straightforwardly using x-ray diffraction, as described in the Examples. The dopant may or may not be incorporated into the aluminum oxide material until a heat treatment step following collection of the materials produced by laser pyrolysis.

### EXAMPLES

### Example 1

### Laser Pyrolysis Synthesis of Alumina With Aerosol Precursors

This example demonstrates the synthesis of delta-aluminum oxide by laser pyrolysis with an aerosol. Laser pyrolysis was carried out using a reaction chamber essentially as described above with respect to FIGS. 4-6.

Aluminum nitrate (Al(NO₃)₂.9H₂O) (99.999%, 1.0 molar) precursor was dissolved in deionized water. The aluminum nitrate precursor was obtained from Alfa Aesar, Inc., Ward Hill, Mass.. The solution was stirred on a hot plate using a magnetic stirrer. The aqueous metal precursor solutions were carried into the reaction chamber as an aerosol. C₂H₄ gas was used as a laser absorbing gas, and nitrogen was used as an inert diluent gas. The reactant mixture containing the metal precursors, N₂, O₂ and C₂H₄ was introduced into the reactant nozzle for injection into the reaction chamber. Additional parameters of the laser pyrolysis synthesis relating to the particles of Example 1 are specified in Table 1.

TABLE 1

| {PR1VATE } | 1 | 2 |
|---|---|---|
| Pressure (Torr) | 200 | 180 |
| Nitrogen F.R.- | 5 | 5 |
| Window (SLM) | | |
| Nitrogen F.R.- | 20 | 34 |
| Shielding (SLM) | | |
| Ethylene (SLM) | 2 | 1.25 |
| Diluent Gas | 40 | 20 |
| (argon) (SLM) | | |
| Oxygen (SLM) | 3.17 | 3.87 |
| Laser Input | 910 | 1705 |
| (Watts) | | |
| Laser Output | 700 | 1420 |
| (Watts) | | |
| Production Rate | 1.3 | 0.7 |
| (g/hr) | | |
| Precursor Delivery | 2.8 | 1.8 |
| Rate to Atomizer* | | |
| (ml/min) | | |
| Surface Area of | 13 | 26 |
| Powders (m²/g) | | |

slm = standard liters per minute
Argon - Win. = argon flow past windows 412.
Argon - Sld. = argon flow through slot 462.
*A majority of the aerosol precursor returns down the nozzle and is recycled.

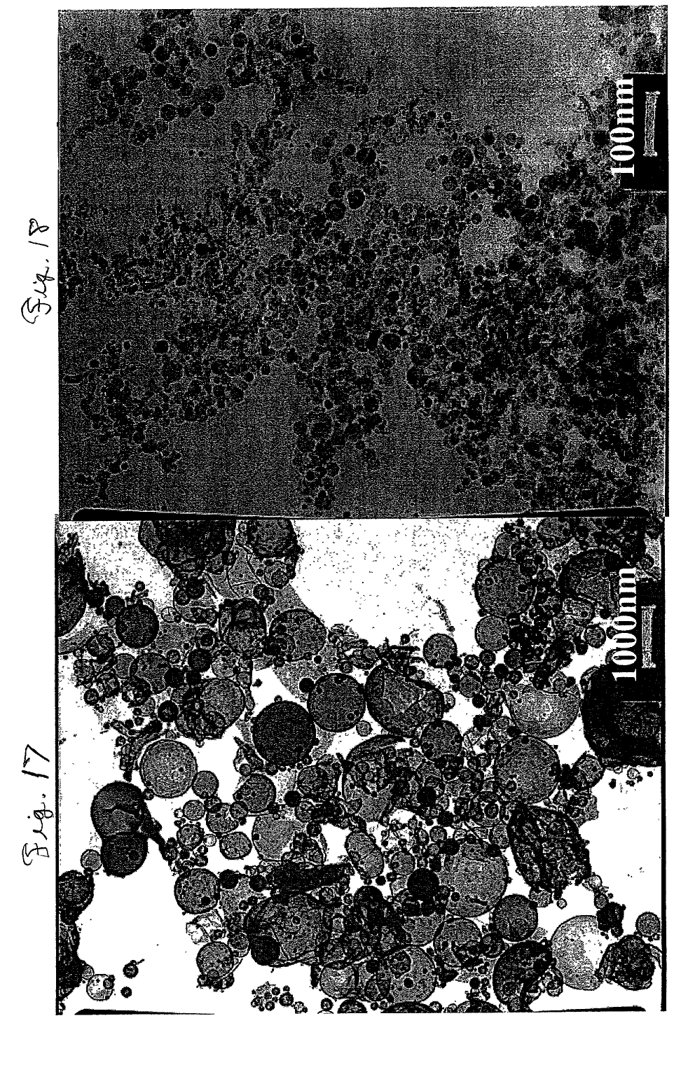

To evaluate the atomic arrangement, the samples were examined by x-ray diffraction using the Cu(Kα) radiation line on a Rigaku Miniflex x-ray diffractometer. X-ray diffractograms for a sample produced under the conditions specified in column 1 and 2 of Table 1 are shown in FIG. 16, respectively noted 1 and 2 corresponding to samples 1 and 2. In each of the samples, crystalline phases were identified that corresponded to delta-aluminum oxide (Al₂O₃) by comparison with known diffractograms.

Also, BET surface areas were measured for the two particle samples produced by laser pyrolysis under the conditions specified in columns 1 and 2 of Table 1. The BET surface area was determined with a Micromeritics Tristar 3000™ instrument using an N₂ gas absorbate. The samples produced by laser pyrolysis as specified in columns 1 and 2 of Table 1 had BET surface areas of 13 m²/g and 26 m²/g, respectively. These results suggest that the particles produced under the conditions in column 2 of Table 1 have a smaller particle size. Impurity levels of C, H, Cl and N were determined by atomic adsorption to be generally less than about 1% by weight.

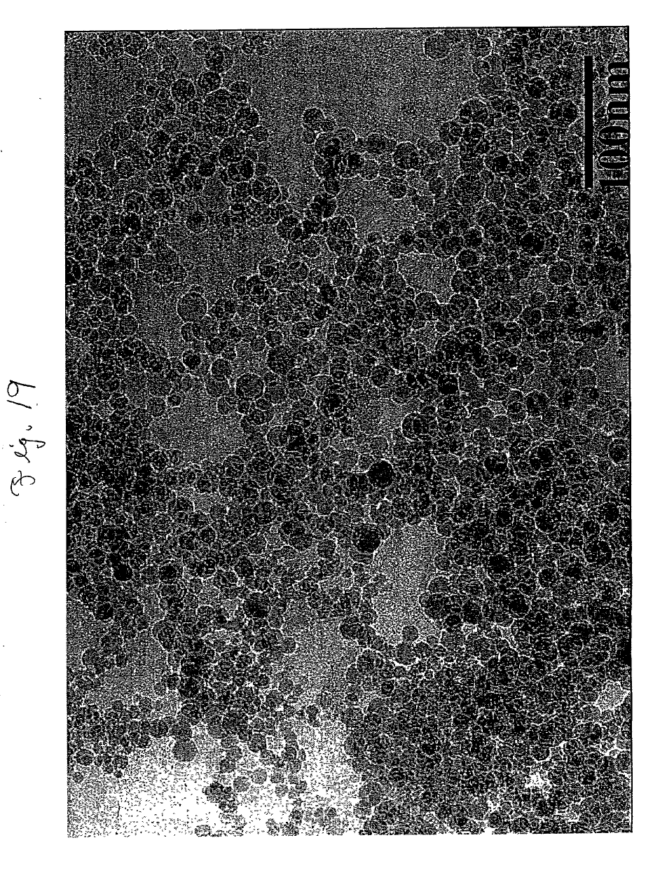

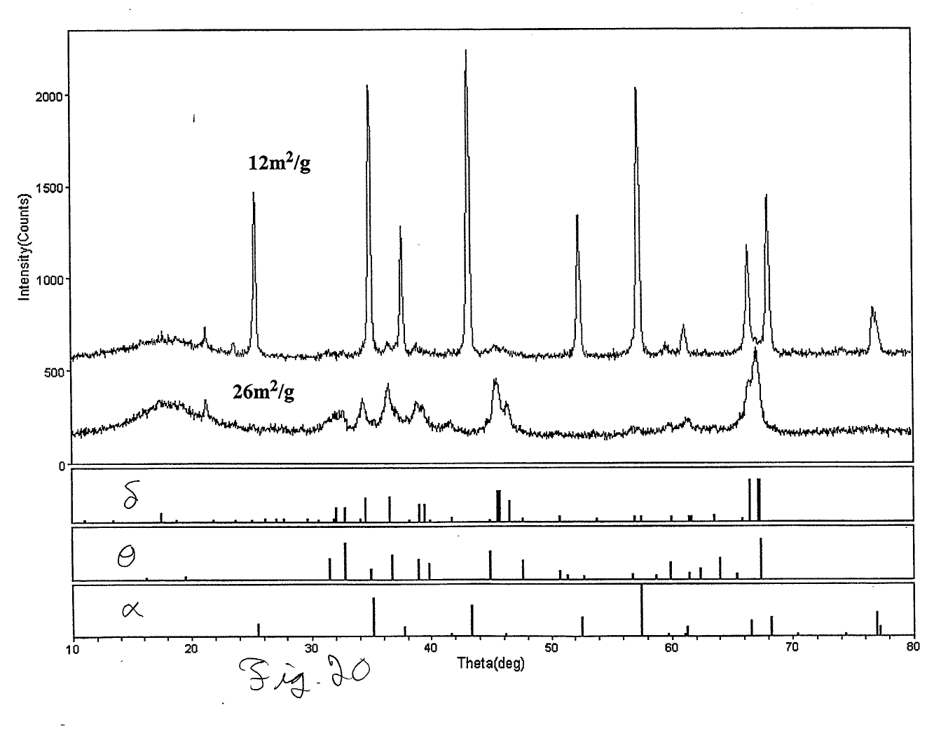

Transmission electron microscopy (TEM) photographs were obtained of aluminum oxide nanoparticles produced under the conditions of column 2 in Table 1. The TEM micrograph is shown in FIG. 17. The particles generally had a spherical morphology. Transparent shell-type particles are visible in the micrograph along with dense particles. Adjustment of the reaction conditions can be used to obtain uniform dense particles.

### Example 2

### Laser Pyrolysis Synthesis of Alumina With Vapor Precursors.

This example describes the laser pyrolysis synthesis of delta-aluminum oxide using vapor precursors. The reaction was carried out in a chamber comparable to the chamber shown in FIG. 4 with a rectangular inlet nozzle with a 1.75 inch×0.11 inch opening for vapor/gaseous reactants.

Aluminum chloride (AlCl₃) (Strem Chemical, Inc., Newburyport, Mass.) precursor vapor was carried into the reaction chamber from a sublimation chamber where N₂ gas was passed over heated aluminum chloride solid. The reactant gas mixture containing AlCl₃, O₂, nitrogen and C₂H₄ was introduced into the reactant gas nozzle for injection into the reactant chamber. C₂H₄ gas was used as a laser absorbing gas. Nitrogen was used as a carrier gas as well as an inert gas to moderate the reaction. Molecular oxygen was used as an oxygen source. Runs with excess oxygen or stoichiometric amounts of oxygen produced the best powders.

Representative reaction conditions for the production of aluminum oxide particles with vapor precursors are described in Table 2.

TABLE 2

| Sample{PRIVATE } | 3 | 4 | 5 | 6 |
|---|---|---|---|---|
| BET Surface Area | 83 | 137 | 173 | 192 |
| Pressure (Torr) | 120 | 120 | 120 | 120 |
| N₂-Win (slm) | 10 | 10 | 10 | 10 |
| N₂-Sld. (slm) | 2.8 | 2.8 | 2.8 | 2.8 |
| Ethylene (slm) | 1.25 | 0.725 | 0.725 | 1.25 |
| Carrier Gas - N₂ (slm) | 0.72 | 0.71 | 0.71 | 0.72 |
| Oxygen (slm) | 2.4 | 0.7 | 0.7 | 3.8 |
| Laser Power-Input | 1500 | 772 | 760 | 1500 |
| (Watts) | | | | |
| Laser Power-Output | 1340 | 660 | 670 | 1360 |
| (Watts) | | | | |

sccm= standard cubic centimeters per minute
slm = standard liters per minute
Argon-Win. = argon flow past windows 412.
Argon-Sld.= argon flow through slot 462.

An x-ray diffractogram of product nanoparticles for samples 3-5 produced under the conditions in Table 2 are shown in FIG. 16 as the top three spectra appropriately labeled. Samples 3-5 had x-ray diffractograms characteristic of gamma- aluminum oxide. However, with reduced particle sizes, the diffraction peaks broadened out, as expected, such that individual peaks were not resolved. The BET surface areas were measured as described in Example 1. The values of BET surface area are listed in Table 2. These particles had higher surface areas indicating smaller particle sizes than the particles produced with aerosol precursors. Impurity levels of C, H, Cl and N were determined by atomic adsorption to be generally less than about 1% by weight.

A transmission electron micrograph was obtained for a similar aluminum oxide powder produced by laser pyrolysis with vapor precursors having a BET surface area of about 77 m²/g. The micrograph is shown in FIG. 18. The particles had an average particle size well under 100 nm. Also, a TEM micrograph for a sample produced under the conditions of the second column in Table 2 (sample 4) was obtained. The micrograph is shown in FIG. 18. The particles look highly crystalline with crystal facets being clearly visible. These particles had an average particle size of less than about 20 nm and a very uniform particle size distribution. Calculated surface areas based on the observed particle sizes were approximately the same as the measured BET surface areas, indicating that the particles were dense, non-porous particles.

Sample 6 produced under the conditions in column 4 of Table 2 was delta-aluminum oxide with a carbon coating. The presence of the carbon coating allowed for the heat treating the aluminum oxide particles in a reducing atmosphere for the production of alpha-aluminum oxide without sintering the particles, as described farther below. The production of metal oxide particles with carbon coatings is described further in copending and commonly assigned U.S. patent application Ser. No. 09/123,255 to Bi et al., entitled “Metal (Silicon) Oxide /Carbon Composites,” incorporated herein by reference.

### Example 3

### Heat Treatment of Alumina Particles From Laser Pyrolysis

The starting materials for the heat treatment were aluminum oxide particles produced under the conditions described in Examples 1 and 2. The heat treatment resulted primarily in the production of alpha-aluminum oxide from delta-aluminum oxide.

The nanoparticles were heat treated at in a box by placing the samples in a 2 inch×6 inch alumina crucible. Firing was performed in laboratory air conditions except for heat treatment with a forming gas. The nanoparticles were converted by the heat treatment to crystalline alpha-Al₂O₃ particles with some of the samples having a minority portion of theta-Al₂O₃, as described below for specific samples.

A first heat treated sample (H1) was prepared from a delta-aluminum oxide produced as described the second column of Table 1. The sample was heated as specified in Table 3 and they were cooled by the rate of the natural cooling of the furnace when it is turned off.

TABLE 3

| Sample | H1 | H2 | H3 | H4 | H5 |
|---|---|---|---|---|---|
| Temperature | 1200 | 1200 | 1200 | 1265 | 1250 |
| (° C.) | | | | | |
| Heating | 2 | 12 | 60 | 12 | 3 |
| Time | | | | | |
| (hours) | | | | | |
| Heating Rate | 15 | 15 | 15 | 15 | 7 |
| (° C./min.) | | | | | |
| Gas | Ambient | Ambient | Ambient | Ambient | Ambient |
| Properties | Air | Air | Air | Air | Air |

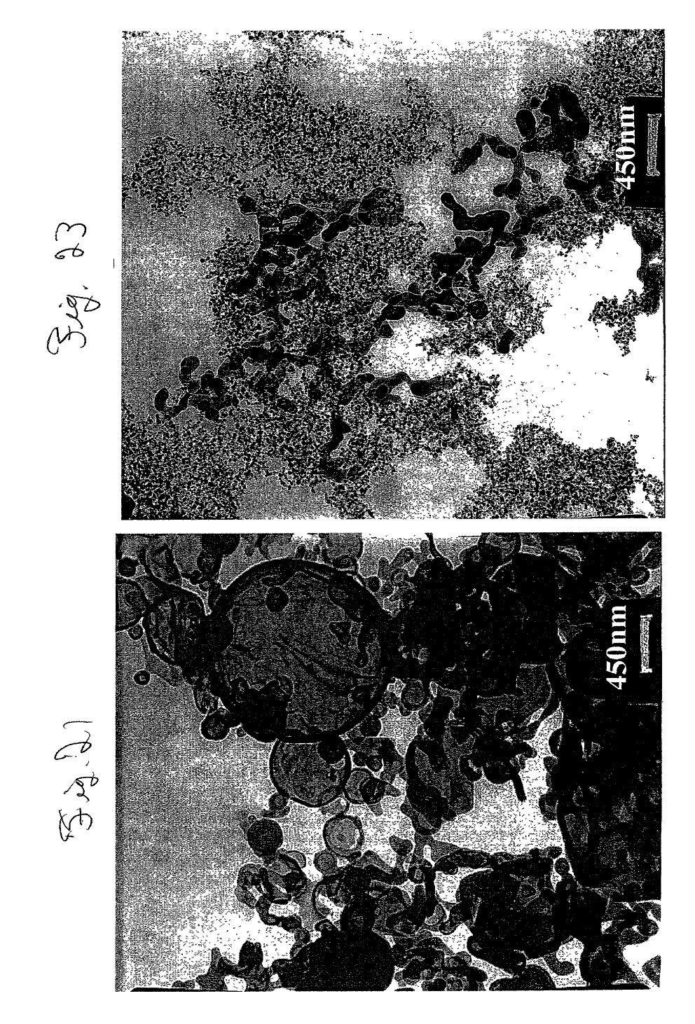

The crystal structure of the resulting heat treated particles (H1) was determined by x-ray diffraction. An x-ray diffractogram of sample H1 along with a diffractogram of the corresponding powders without heat treatment is presented in FIG. 20. The top diffractogram was produced with the heat treated material and the lower diffractogram is the sample before heat treatment. The heat treatment converted the initially delta-aluminum oxide into relatively pure phase alpha-aluminum oxide with a very small amount of theta-aluminum oxide. Following heat treatment, the particles had a BET surface area of about 12 m²/g. The drop in surface area generally would correspond to collapse of the hollow particles into dense particles, although some sintering may also take place.

Transmission electron microscopy (TEM) was used to evaluate particle sizes and morphology of the heat treated samples. A TEM micrograph of sample H1 is shown in FIG. 21. As seen in FIG. 21, not all of the hollow particles have collapsed into dense particles. The uniformity of the material can be improved by reducing the reactant density in the laser reaction zone.

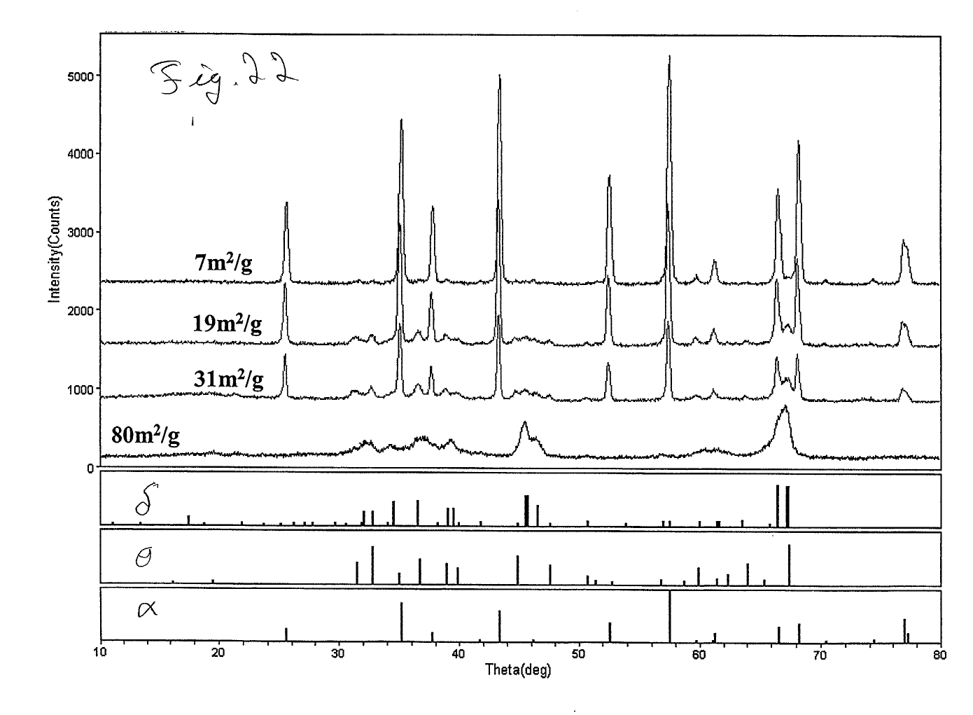

In addition, a sample of delta-aluminum oxide produced with vapor phase reactants by laser pyrolysis was heat treated to generate mixed phase aluminum oxide with a majority alpha-aluminum oxide and some remaining delta-aluminum oxide and theta aluminum oxide. Three different samples (H2, H3, H4) of the same starting material produced as described in Example 2were heat treated under conditions specified in Table 3. The samples (H2, H3, H4) had BET surface areas of 31 m²/g, 19 m²/g and 7 m²/g, respectively. The x-ray diffractograms for the three heat treated samples are shown in FIG. 22. The sample with 31 m²/g surface area was mostly converted to alpha-aluminum oxide, although some delta-aluminum oxide remained. The 7 m²/g sample was pure alpha-aluminum oxide with high crystallinity, according to the x-ray diffractogram spectrum.

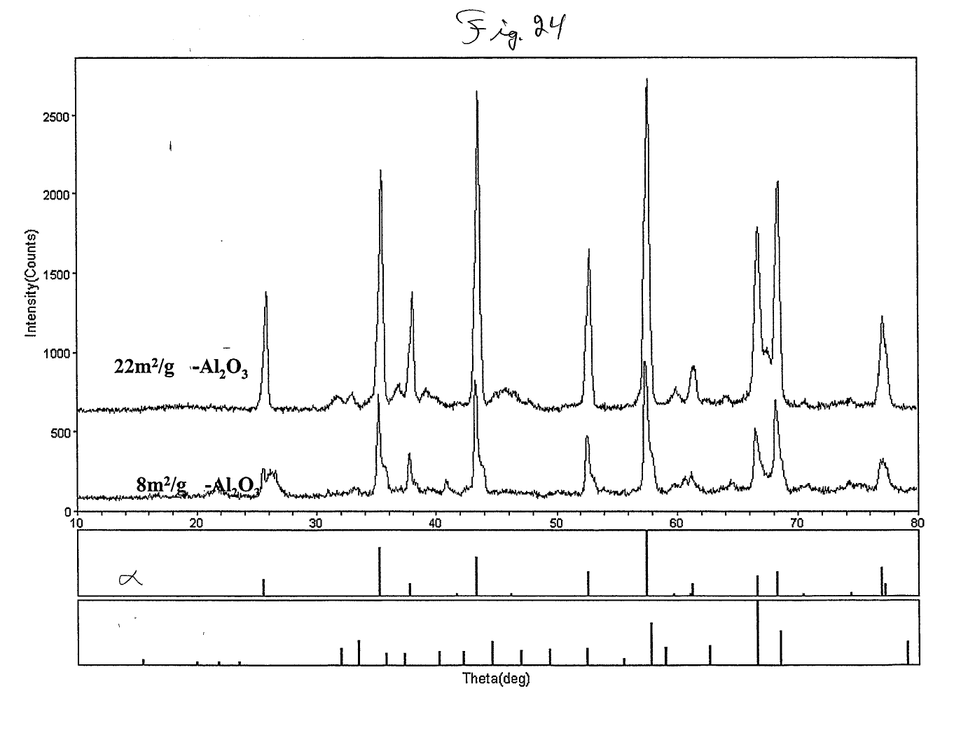

A TEM micrograph of the 31 m²/g heat treated sample is shown in FIG. 23. Small uniform particles are visible along with larger interconnected structures. Selected area diffraction was used to differentiate the delta-aluminum oxide particles from alpha-aluminum oxide particles. Selected area diffraction of the smaller particles in the TEM micrograph indicated that the particles were highly crystalline with d-spacing values that matched well with delta-phase or theta-phase crystals. Overall, the sample was roughly 81% alpha-phase.

For comparison, the x-ray diffractogram spectrum of a heat treated sample (H5) with 22 m²/g surface area is shown in FIG. 24 along with the x-ray diffractogram spectrum of a commercial sample of delta-aluminum oxide from St. Gobain (France) having a BET surface area of 8 m²/g. The heat treat sample H5 was produced from a sample originally produced by laser pyrolysis with vapor precursors with heat treatment conditions specified in Table 3. The heat treated sample was majority alpha-aluminum oxide with a small amount of delta-aluminum oxide. The commercial sample had unidentified peaks corresponding to an unknown contaminant. An elemental analysis of the commercial sample identified approximately 9 weight percent contaminants compared with less than about 0.5 weight percent for the heat treated laser pyrolysis sample.

The embodiments above are intended to be illustrative and not limiting. Additional embodiments are within the claims. Although the present invention has been described with reference to preferred embodiments, workers skilled in the art will recognize that changes may be made in form and detail without departing from the spirit and scope of the invention.

What is claimed is:

1. A collection of particles comprising crystalline aluminum oxide selected from the group consisting of delta-Al₂O₃ and theta-Al₂O₃, the particles having an average diameter less than about 100 nm.

2. The collection of particles of claim 1 wherein the crystalline aluminum oxide comprises delta-Al₂O₃.

3. The collection of particles of claim 1 wherein the particles comprise theta-Al₂O₃.

4. The collection of particles of claim 1 wherein the particles have an average diameter less than about 50 nm.

5. The collection of particles of claim 1 wherein the particles have an average diameter less than about 25 nm.

6. The collection of particles of claim 1 wherein the particles have a BET surface area from about 30 m²/g to about 200 m²/g.

7. The collection of particles of claim 1 wherein the particles have a BET surface area from about 100 m²/g to about 200 m²/g.

8. The collection of particles of claim 1 wherein effectively no particles have a diameter greater than about four times the average diameter of the collection of particles.

9. The collection of particles of claim 1 wherein effectively no particles have a diameter greater than about three times the average diameter of the collection of particles.

10. The collection of particles of claim 1 wherein the collection of particles have a distribution of particle sizes such that at least about 95 percent of the particles have a diameter greater than about 40 percent of the average diameter and less than about 160 percent of the average diameter.

11. The collection of particles of claim 1 comprising aluminum oxide particles with a dopant metal oxide, wherein the aluminum oxide particles have from about 0.05 mole percent to about 5 mole percent dopant based on a ratio of dopant metal to aluminum.

12. A collection of particles comprising doped aluminum oxides, the particles having an average diameter less than about 500 nm.

13. The collection of particles of claim 12 having an average diameter from about 3 nm to about 150 nm.

14. The collection of particles of claim 12 having an average diameter from about 3 nm to about 50 nm.

15. The collection of particles of claim 12 wherein the doped aluminum oxide particles comprise particles with a gamma-aluminum oxide structure.

16. The collection of particles of claim 12 wherein the doped aluminum oxide particles comprise particles with alpha-aluminum oxide structure.

17. The collection of particles of claim 12 wherein the dopant is selected from the group consisting of cesium oxide (Cs₂O), rubidium oxide (Rb₂O), thallium oxide (Tl₂O), lithium oxide (Li₂O), sodium oxide (Na₂O), potassium oxide (K₂O), beryllium oxide (BeO), magnesium oxide (MgO), calcium oxide (CaO), strontium oxide (SrO), barium oxide (BaO) and combinations thereof.

18. The collection of particles of claim 12 wherein the dopant comprises cobalt oxide (Co₃O₄).

19. The collection of particles of claim 12 wherein the dopant comprises zirconium oxide (ZrO₂).

20. The collection of particles of claim 12 wherein the aluminum oxide particles comprise from about 0.01 mole percent to about 10 mole percent based on a ratio of dopant metal to aluminum.

21. The collection of particles of claim 12 wherein the aluminum oxide particles comprise from about 0.05 mole percent to about 5 mole percent based on a ratio of dopant metal to aluminum.

22. A coating comprising a collection of particles of claim 12.

23. A method for the production of doped aluminum oxide particles, the method comprising reacting a flowing reactant stream comprising an aluminum precursor, an oxygen source and a dopant precursor to form doped aluminum oxide particles in a flowing product stream.

24. The method of claim 23 wherein the reactant stream comprises an aerosol.

25. The method of claim 24 wherein the aerosol comprises the aluminum precursor and the dopant precursor.

26. The method of claim 23 wherein the aluminum precursor comprises a compound that includes the oxygen source.

27. The method of claim 23 wherein the oxygen source is O₂.

28. The method of claim 23 wherein the reacting of the reactant stream is driven by heat absorbed from a light beam.

29. The method of claim 23 further comprising directing the flowing stream with doped aluminum oxide particles to a substrate to form a coating.

30. A method for producing product submicron crystalline-aluminum oxide particles, the method comprising heating a collection of precursor submicron carbon-coated aluminum oxide particles in a reducing environment to convert the crystal structure of the aluminum oxide particles to produce product crystalline-aluminum oxide particles, wherein the product crystalline aluminum oxide particles comprise particles with a different crystal structure than the precursor aluminum oxide particles.

31. The method of claim 30 wherein the collection of precursor particles comprise gamma-aluminum oxide.

32. The method of claim 30 wherein the collection of precursor particles comprise delta-aluminum oxide.

33. The method of claim 30 wherein the heating is performed at a temperature from about 1000° to about 1400°.

34. The method of claim 30 wherein the product crystalline aluminum oxide particles comprise alpha-aluminum oxide.

35. The method of claim 30 further comprising heating the product crystalline-aluminum oxide particles in an oxidizing environment to remove the carbon coating.
